(19) United States
(12) Patent Application Publication
(10) Pub. No.: US 2024/0173712 A1
(43) Pub. Date: May 30, 2024

(54) Device for Liquid Handling

(71) Applicant: Takara Bio USA, Inc., San Jose, CA (US)

(72) Inventors: Bradley L. Griswold, San Jose, CA (US); Mike Slater, Los Gatos, CA (US); Patricio A. Espinoza Vallejos, San Francisco, CA (US); Tiffany M. Ding, San Jose, CA (US); Zhiliang Wan, Saratoga, CA (US)

(21) Appl. No.: 18/519,715

(22) Filed: Nov. 27, 2023

Related U.S. Application Data
(60) Provisional application No. 63/428,509, filed on Nov. 29, 2022.

(51) Int. Cl. B01L 3/02

(52) U.S. Cl. CPC B01L 3/0227; B01L 3/0237; B01L 2200/0642; B01L 2200/0689; B01L 2400/0478

(57) ABSTRACT

Liquid dispensing devices are provided. Aspects of the devices include an actuator comprising a movable shaft; an elongated body, e.g., a cylinder, comprising a central channel, a proximal end and a distal end, wherein the distal end comprises an orifice; and a plunger comprising a proximal end and a distal end, wherein: the proximal end is mechanically coupled to the movable shaft, and at least a portion of the distal end of the plunger is moveably positioned within the central channel. Also provided are systems that incorporate the liquid handling device, which may be present as an array of liquid handling devices, as well as methods of using the devices and systems, e.g., in liquid dispensing applications.

### CROSS-REFERENCE TO RELATED APPLICATION

Pursuant to 35 U.S.C. § 119(e), this application claims priority to the filing date of the U.S. Provisional Patent Application Ser. No. 63/428,509, filed Nov. 29, 2022, the disclosure of which application is herein incorporated by reference.

### INTRODUCTION

Liquid dispending devices are known in the art. The challenges with the state of the art for dispensing small volumes (e.g., 10 nL to 300 nL) is not with the actual dispensing, but in how the liquid to be dispensed is handled in the device, including delivery of the liquid to the point where the dispense will occur. Most frequently, systems for dispensing small liquid volumes must have a large reservoir of fluid present to dispense even though they are only dispensing small nanoliter volumes.

Unfortunately, fluids of interest, for example, experimental samples, are often only available in microliter (IL) or nanoliter (nL) quantities. This presents a significant problem for liquid handling devices. In order to use small quantities of fluid in current dispensing systems, it is required to have a large volume of “working” fluid as well as the actual fluid of interest. These fluids must also be separated from each other during the aspiration and dispense of the fluid of interest. This is cumbersome and requires a complicated array of tubing, valves, reservoirs and pumps. The fluid of interest must also be kept from mixing with the “working” fluid. This can involve the use of an “air gap” separating the two fluids or placing a third, higher viscosity fluid, between the two fluids. All of this adds complexity and difficulty controlling the aspiration and dispense steps of liquid handling devices.

A second consideration that illustrates the limitations of the current state of the art, as stated above, is that small, dispensed quantities of liquid in current dispensing systems often require a larger volume of that liquid to supply the dispenser mechanism. This creates a “dead volume” of liquid that supplies the dispenser mechanism, where the liquid volume that exists in the feed reservoir and feed lines that supply the dispensing mechanism is wasted and is never actually dispensed, for example, into the well of a multi-well plate or chip. One configuration of a liquid dispensing apparatus of the prior art is shown in FIG. 15, which depicts a micro-solenoid nanofluidic device (MSND).

### SUMMARY

The inventors have realized that: there is a need in the art for improved and simplified systems for liquid handling that reduce the complexity of the devices for dispensing very small volumes of sample or reagents, e.g., nanoliter (nL) volumes of liquids; there is a need in the art for liquid handling devices that do not result in large dead volumes of reagent solutions or sample liquids; and that there is a need in the art for liquid handling systems that can accommodate reagent solutions and samples that have very small volumes, for example, between 10 nL and 300 nL.

The disclosure relates to devices and systems for liquid handling (e.g., aspirating and dispensing) small volumes of liquid samples, for example, liquid samples of about 10 nL to about 300 nL. The present disclosure provides solutions and benefits over the state of the art. In some aspects, the devices and systems described herein comprise an actuator, such as a linear actuator, functionally coupled to a plunger that is movably positioned within the central channel of an elongated body, e.g., a cylinder, wherein motion of the actuator results in a corresponding motion of the plunger, thereby resulting in either aspiration of liquid into the elongated body or dispensing of liquid out from the elongated body.

In some aspects, the disclosure provides devices for liquid handling, those devices comprising (a) an actuator, such as a linear actuator, comprising a movable shaft; (b) an elongated body, e.g., a cylinder, having a central channel, a proximal end and a distal end, wherein the distal end comprises an orifice, and (c) a plunger having a proximal end and a distal end, wherein (i) the proximal end is mechanically coupled to the movable shaft, and (ii) at least a portion of the distal end of the plunger is moveably positioned within the central channel of the cylinder.

In other aspects, the disclosure provides systems, i.e., apparatuses, for the simultaneous handling of a plurality of liquid samples, the systems comprising (i) a nanosyringe array comprising a plurality of nanosyringes, each nanosyringe comprising:
(a) an actuator, such as a linear actuator, comprising a movable shaft;
(b) an elongated body, e.g., a cylinder, having a central channel, a proximal end and a distal end, wherein the distal end comprises an orifice;
(c) a plunger having a proximal end and a distal end, wherein:
   the proximal end is mechanically coupled to the movable shaft, and
   at least a portion of the distal end of the plunger is moveably positioned within the central channel of the elongated body,
   where the plurality of nanosyringes is configured to dispense, and in some instances also aspirate, liquid;

In some instances, the system further comprises (ii) a computer control system and optionally an operably coupled user interface, for controlling the actuator, thereby controlling the nanosyringe liquid dispensing, and in some instances liquid aspirating. The system may be configured to accommodate a multi-well device comprising a plurality of fluidically isolated wells, e.g., where the system is capable of positioning the multi-well device in a configuration to receive liquid dispensed from the nanosyringes.

In still other aspects, the disclosure provides methods for dispensing a liquid into a well of a multi-well device. Embodiments of the methods may include:
(a) providing:
   (i) a nanosyringe comprising
      (A) an actuator, such as a linear actuator, comprising a movable shaft;
      (B) an elongated body, e.g., a cylinder, having a central channel, a proximal end and a distal end, wherein the distal end comprises an orifice; and
      (C) a plunger having a proximal end and a distal end, wherein:
         the proximal end is mechanically coupled to the movable shaft, and at least a portion of the distal end of the plunger is moveably positioned within the central channel of the elongated body; and
   (ii) a multi-well device comprising a plurality of fluidically isolated wells;
(b) positioning the multi-well device in a configuration to receive liquid dispensed from the nanosyringe; and the method further comprising:
(c) positioning the distal end of the cylinder into a source reservoir, e.g., a source reservoir plate, containing the liquid to be dispensed;
(d) retracting the actuator shaft, thereby retracting the plunger in the central channel, and thereby aspirating the liquid into the central channel;
(e) repositioning the distal end of the elongated body above a well of the multi-well device; and
(f) extending the linear actuator shaft, thereby extending the plunger in the central channel, and thereby dispensing the liquid from the central channel into the well of the multi-well device.

A full and enabling description of the subject technology, as well as the advantages of this technology over the state of the art, are set forth in the presently provided written description, examples, and appended drawings. It is to be understood that the present disclosure is not intended that the scope of the invention be limited to the particular embodiments described herein, as one of skill in the art will recognize that the description provides ample guidance to make and use embodiments not expressly articulated or shown herein.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 provides a schematic of a nanosyringe of the disclosure showing a coaxial alignment of the linear actuator shaft and the nanosyringe plunger.

FIG. 2 provides a schematic showing a detailed portion of the nanosyringe shown in FIG. 1.

FIG. 3 provides a schematic of a nanosyringe of the disclosure showing a non-coaxial alignment of the linear actuator shaft and the nanosyringe plunger.

FIG. 4 provides a schematic of one embodiment of the nanosyringe of the disclosure that incorporates a plunger seral at the distal end of the plunger.

FIGS. 5A and 5B provide illustrations of a nanosyringe of the disclosure, alternatively with the nanosyringe plunger extended into the nanosyringe cylinder (FIG. 5A) and with the nanosyringe plunger withdrawn from the nanosyringe cylinder (FIG. 5B).

FIG. 6 provides an illustration of a nanosyringe of the description containing a liquid during the dispense phase.

FIGS. 7A through 7H show embodiments of nanosyringe cylinder distal ends, including cylinders that have an integrated orifice as well as cylinders that comprise an orifice plate.

FIG. 8 shows a schematic of a liquid handing apparatus of the present disclosure.

FIG. 9A shows a schematic of a liquid handing apparatus of an embodiment of the present disclosure.

FIG. 9B shows a schematic of a liquid handing apparatus of another embodiment of the present disclosure.

FIG. 10 shows a schematic of a nanosyringe array as can be used in a liquid handing apparatus of the present disclosure.

FIG. 11 shows a schematic of a nanosyringe array as can be used in a liquid handing apparatus of the present disclosure.

FIG. 12 shows a schematic of a nanosyringe array as can be used in a liquid handing apparatus of the present disclosure.

FIG. 13 shows a schematic of a moveable stage comprising a multi-well chip as can be used in a liquid handing apparatus of the present disclosure.

FIG. 14 shows a schematic of a single nanosyringe as can be used in a liquid handing apparatus of the present disclosure.

FIG. 15 shows a general schematic of a liquid handling apparatus as known in the art, namely a microsolenoid nanofluidic device (MSND). This MSND system uses a combination of microsolenoid values, a gas pressure source (helium) and a syringe pump to either dispense liquid via pressure from the pressure source from a fluid reservoir or aspiration by the action of the syringe pump.

FIG. 16 shows the results of an experiment examining the dispense accuracy of a nanosyringe of the present disclosure, tested over the range of 30 nL to 300 nL using water as the dispense liquid.

FIGS. 17A and 17B show the results of two experiments examining the repeatability of a dispense volume test of either 35 nL (FIG. 17A) or 100 nL (FIG. 17B).

FIG. 18 shows the results of an experiment examining the accuracy of liquid dispense events over a range of volumes from 20 nL to 50 nL.

FIG. 19 shows an image of an ICELL8 chip containing 5,184 nanowells, following a test dispense pattern.

FIGS. 20A and 20B provide schematics of one embodiment of the liquid handling device described herein, namely a nanosyringe device that further comprises a side port in the nanosyringe cylinder

FIGS. 21A and 21B provide illustrations of one embodiment of the liquid handling device described herein, namely a nanosyringe device that uses a coupling between the linear actuator shaft and the plunger that is not a permanent mechanical coupling.

FIG. 22 provides a graphic illustrating one embodiment of the velocity and acceleration characteristics of the linear actuator, and therefore the plunger, of the nanosyringe device.

FIG. 23 provides a workflow schematic illustrating use of the Takara Bio USA, Inc. SMART-Seq® Pro application protocol for transcriptome analysis of single cells, which was used in conjunction with a nanosyringe system as described herein.

FIGS. 24A and 24B show images obtained following PCR reagent dispensing testing into ICELL8® 5,184 well chips (Takara Bio USA Inc.).

FIG. 25 shows the qPCR linearity of two liquid dispensing systems of the current disclosure as compared to a prior art device.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. However, it will be apparent to one of skill in the art that the subject technology may be practiced without these specific details. In some instances, well-known structures and components are shown in block diagram form in order to avoid obscuring the concepts of the subject technology.

Unless otherwise defined, scientific, mechanical, engineering and technical terms used in connection with the present teachings provided herein have the meanings that are commonly understood by one of ordinary skill in the art. The terminology used in the description of the disclosure herein is for the purpose of describing particular embodiments only and is not intended to be limiting.

### Definitions

As used in the description of the disclosure and the appended claims, the singular forms “a,” “an,” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”). For instance, the term “A and/or B” includes A, B, and (A and B). Further, unless otherwise required by context, singular terms shall include pluralities and plural terms shall include the singular.

Where a range of values is provided in this disclosure, it is intended that each intervening value between the upper and lower limit of that range and any other stated or intervening value in that stated range is encompassed within the disclosure. For example, if a range of 1 μM to 8 μM is stated, it is intended that 2 μM, 3 μM, 4 μM, 5 μM, 6 μM, and 7 μM are also explicitly disclosed. The range also includes any non-integer value, such as 2.2 μM, 6.33333 μM, etc.

The word “about” means a range of plus or minus 10% of that value, e.g., “about 5” means 4.5 to 5.5, “about 100” means 90 to 100, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

As used herein, “substantially” means sufficient to work for the intended purpose. The term “substantially” thus allows for minor, non-consequential variations from an absolute or perfect state, dimension, measurement, result, or the like such as would be expected by a person of ordinary skill in the art but that do not appreciably affect overall performance. When used with respect to numerical values or parameters or characteristics that can be expressed as numerical values, “substantially” means within 10%, or within 5% or less, e.g., within 2% or within 1% of the target value.

As used herein, the term “plurality” can be any integer greater than one, for example, 2, 3, 4, 5, 6, 7, 8, 9, 10, 20, 50, 100, 1,000, 10,000, 100,000, 1×10⁶, or more.

As used herein, the unit length of “millimeter” refers to the measure of 0.001 meters, commonly written as mm. As used herein, the unit length of “micron” refers to and is synonymous with the term micrometer, which is 0.000001 meters, also written as μm. One millimeter is equivalent to 1,000 microns.

As used herein, the term “mil,” synonymous with the term “thou,” refers to a unit of length that is one thousandth of one inch. That is to say, one mil is synonymous with 0.001 inch. One mil is equivalent to 0.0254 mm, and equivalent to 25.4 microns.

As used herein, the unit volume of “microliter” refers to the measure of 0.000001 (1×10⁻⁶) liters, commonly written as μL. As used herein, the unit volume of “nanoliter” refers to the measure of 0.000000001 (1×10⁻⁹) liters, also written as nL. One microliter is equivalent to 1,000 nanoliters.

As used herein, the terms “operably linked,” “operably coupled,” or similar expressions refer to a interplay of two or more components that are physically joined or otherwise arranged in a manner to achieve some desired result. The juxtaposition, i.e., coupling, of the components can be a physical joining or a non-physical joining, such as a functional joining. The terms “operable linkage” or “operable coupling” shall have a correlative meaning. In some embodiments, two components that are operably coupled are in a relationship that achieves some functional result. For example, a light switch is operably coupled to a light bulb in a light fixture when the light switch can be used to operate the light bulb. In that example, the light switch and light bulb are operably coupled, and further, are electrically coupled.

As used herein, the term “fluidically coupled” refers to two components that have the capacity to be in fluid communication, where fluid has the ability to travel between those components. For example, fluidically coupled components can involve liquid communication via tubes or channels, and can be aided or regulated by any suitable pumps, valves, channels, conduits, solenoids, liquid reservoirs, or the like. Generally, fluidically coupled components share a bounded physical path, for example, a channel or tubing, which defines the fluidic pathway.

As used herein, the terms “fluid” and “liquid” are used interchangeably.

As used herein, the term “cell” is any “biological cell.” Non-limiting examples of biological cells include eukaryotic cells, plant cells, animal cells, such as mammalian cells, insect cells, avian cells, fish cells, or the like, prokaryotic cells, bacterial cells, fungal cells, protozoan cells, or the like, cells dissociated from a tissue, such as muscle, cartilage, fat, skin, liver, lung, neural tissue, and the like, immune cells, such as T cells, B cells, natural killer cells, macrophages, and the like, embryos (e.g., zygotes), oocytes, ova, sperm cells, hybridomas, cultured cells, cells from a cell line, cancer cells, infected cells, transfected and/or transformed cells, reporter cells, and the like. A mammalian cell can be derived from any mammal, e.g., from a human, a mouse, a rat, a horse, a goat, a sheep, a cow, a primate, etc.

As used herein, the term “sample” refers to any liquid composition that is the subject of analysis or contains a component that is the subject of analysis. The nature of the sample is not particularly limited. For example, a liquid comprising cells that will be the subject of full-length transcriptome analysis can be a sample. In other embodiments, the sample comprises not more than one cell or not more than one cell nucleus. In other embodiments, a sample can comprise cell nuclei. The cells or cell nuclei in a sample can be fixed or unfixed. In other embodiments, the sample can comprise a nucleic acid of any nature, for example, DNA (genomic DNA, cfDNA), RNA (e.g., but not limited to, mRNA, rRNA, cfRNA) or hybrid DNA/RNA molecules. A sample can comprise nucleic acids extracted from tissues or cells, or samples can be tissues or cell lysates, or any material derived therefrom.

As used herein, a “biological sample” is a substance or material obtained from any biological source for study, including from the body of a subject. The “biological sample” can be derived from any part of an organism, such as an organ or tissue or cell.

The source of the sample may be blood or any blood constituents; bodily fluids; solid tissue as from a fresh, frozen and/or preserved organ or tissue sample or biopsy or aspirate; and cells from any time in gestation or development of the subject. Samples include, but are not limited to, primary or cultured cells or cell lines, cell supernatants, cell lysates, platelets, serum, plasma, vitreous fluid, ocular fluid, lymph fluid, synovial fluid, follicular fluid, seminal fluid, amniotic fluid, milk, whole blood, urine, cerebrospinal fluid (CSF), saliva, sputum, tears, perspiration, mucus, tumor lysates, and tissue culture medium, as well as tissue extracts such as homogenized tissue, tumor tissue, and cellular extracts, cell lysates, etc. Samples further include biological samples that have been manipulated in any way after their procurement, such as by treatment with reagents, solubilized, or enriched for certain components, such as proteins or nucleic acids, or embedded in a semi-solid or solid matrix for sectioning purposes, e.g., a thin slice of tissue or cells in a histological sample, such as an FFPE sample.

As used herein, a “reagent” or “reagent mix” or “reagents” or similar expressions refer to any materials, reagents, substances, molecules (biological or chemical), alone or in combinations, that are combined with and used to analyze or react with a sample. In some aspects, a reagent is any substance that participates in or is used to carry out any type of test or analysis but is not itself the subject of the analysis. Reagents may be used in a chemical reaction to detect or measure an analyte or analytes in the sample, or to make other substances from components in the sample. Reagents may include positive control analytes—such as nucleic acid templates or cell extracts that can act as a positive control for a chemical or biological reaction

The various embodiments of the present disclosure are further described in detail in the paragraphs below.

### Nanosyringe

In some aspects, the present disclosure provides liquid handling devices capable of one or both aspiration and dispensing from the same orifice, where these devices are termed herein “nanosyringe” devices, which have various benefits over the prior art. The present invention eliminates the complexity of current devices known in the art and is able to manipulate very small volumes of liquids, without the need for large dead volumes of either working fluid or fluid that the researcher desires to dispense to accomplish the aspiration and dispensing of the desired fluid.

In its broadest sense, the present disclosure provides nanosyringe devices and apparatuses comprising the nanosyringe devices, finding use in the dispensing of small volumes of liquids. In some embodiments, the dispense volumes of liquids finding use with the devices of the disclosure are nano-scale volumes, i.e., one (1) nanoliter (nL) to 999 nL. In some embodiments, the device employs dispense volumes ranging from 10 nL to about 300 nL.

In some embodiments, the aspiration volume is the same volume as the volume to be dispensed. In other embodiments, the aspiration volume is larger than a single dispense volume. This is beneficial for making multiple dispense events following a single larger aspiration step. The aspiration volume is not particularly limited and is a function of the holding capacity of the cylinder component of the nanosyringe. In some embodiments, the aspiration capacity of the nanosyringe is about 12,000 nL (i.e., 12 μL). In other embodiments, the nanosyringes have larger capacities, including for example, aspiration capacities of about 15 μL, 20 μL, 25 μL, 30 μL, 40 μL or 50 μL.

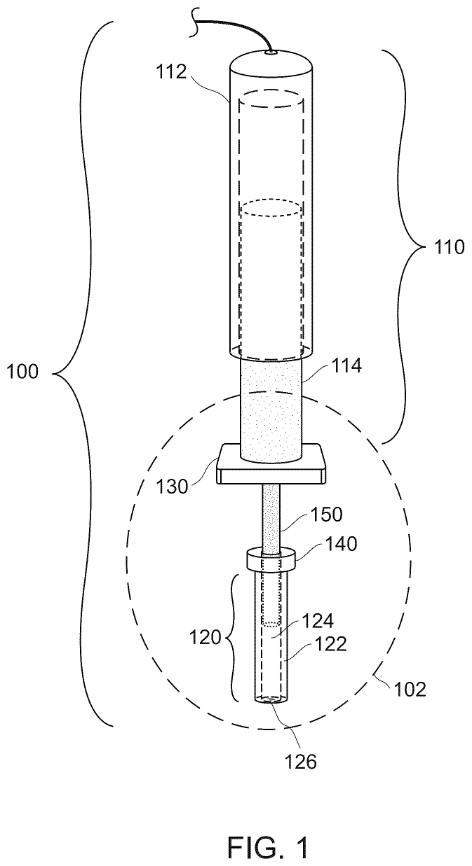

A nanosyringe as used herein comprises essentially three components, which can be understood by the schematic in FIG. 1. These are:
(i) an actuator, e.g., a linear actuator 110; actuators, such as linear actuators, are known generally in the art, and include a motor 112 (e.g., a stepper motor) and a movable shaft 114 that is driven by the motor, where in some instances the shaft moves along a single axis, that is to say, in a straight line, e.g., where the actuator is a linear actuator;
(ii) an elongated body, e.g., a cylinder 120; the elongated body is characterized by a central channel 124, and where the distal end of the elongated body comprises an orifice 126. In some embodiments, the orifice at the distal end of the elongated body is characterized by a diameter that is smaller than the diameter of the central channel. Various orifice and orifice plate dimensions and geometries can be used.
(iii) a nanosyringe plunger 150; the nanosyringe plunger resides and is movably positioned within the central channel 124, and is mechanically joined (i.e., operably coupled) to the linear actuator shaft 114 by any suitable coupling 130. The plunger 150 is characterized by an outer diameter that only slightly smaller, e.g., equal to or less than one thousandth of an inch (termed “mil” or “thou”) smaller, than the diameter of the central channel 124, resulting in a seal between the central channel sidewalls 122 and the plunger 150.

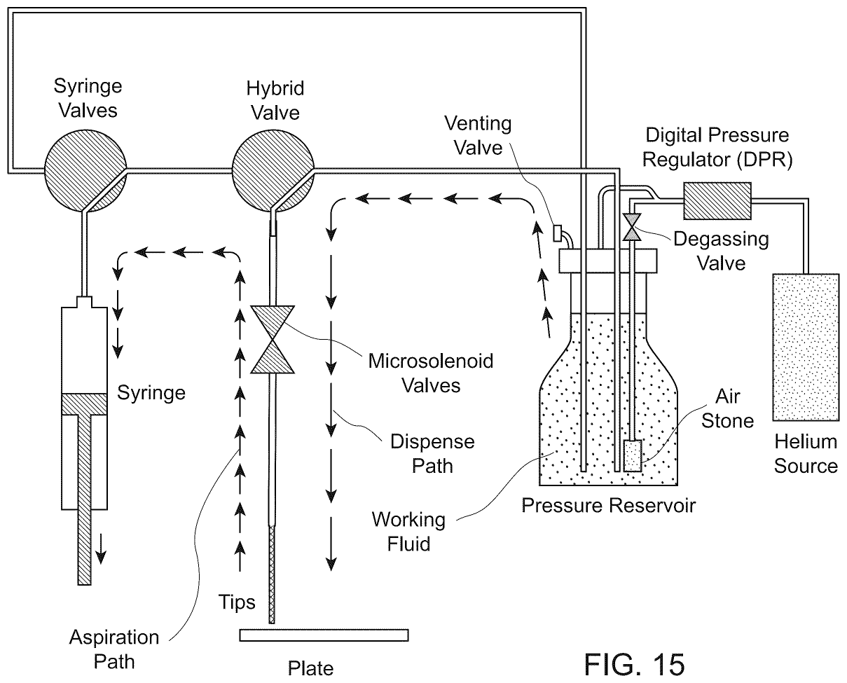

A nanosyringe as described herein provides advantages over the prior art, for example, advantages over a microsolenoid nanofluidic device (MSND) as shown in the schematic provided in FIG. 15. Small, dispensed quantities of liquid in current dispensing systems often require a larger reservoir of that liquid to supply the dispenser mechanism, which creates a “dead volume” of liquid that supplies the dispenser mechanism, which fluid is wasted and never actually dispensed. That configuration of the prior art is shown in FIG. 15. As shown in that figure, there are two fluidic paths, one for dispensing and one for aspirating. For dispensing, the hybrid valve connects the pressure reservoir to the dispensing tip. There is a microsolenoid valve that acts as a gate for the fluid, which can be opened for long periods of time for flushing the dispensing tips, or for short periods of time for dispense. One advantage of the present nanosyringe as shown in FIG. 1 is that the nanosyringe is a displacement technology, where there is a linear relationship between the volume being manipulated and the action of the linear actuator.

For aspiration in the MSND, the hybrid valve switches to connect the dispensing tip to a syringe pump. The syringe moves the plunger down to create a negative pressure and draw fluid up through the dispensing tip. The mixing of the working fluid with the fluid that is desired to be dispensed is one of the biggest challenges of the prior art, because to accommodate this, one needs to aspirate a significantly larger volume of the desired fluid or incorporate an air gap, which adds unwanted springiness to the system and negatively impacts the dispense quality. The nanosyringe as described provides the benefit of greatly reducing the sample and reagent aspirated overhead volume, since there is no need for a working fluid and thus no requirement to keep the dispensed fluid and working fluid separated. The nanosyringes as described herein require minimal dead volume as compared to prior art devices.

The Prior Art system requires a large working fluid volume to supply the dispenser mechanism. It is critical that this working fluid does not mix with the dispensed fluid. It is also critical to degas the working fluid prior to use. Degasing the working fluid in the fluidic reservoir requires a series of steps, including the opening of a venting valve to a helium source. The helium is pushed through an air stone which is positioned at the bottom of the tank, and degasses the working fluid, then the valves are switched back to their original position for dispensing. The nanosyringes have the benefit that there is no working fluid so there is no need to degas any part of the system.

This type of prior art dispense system as shown in FIG. 15 can be prohibitively expensive where there is a significant dead volume and when the liquids that are being dispensed contain, for example, reagents (e.g., enzymes) that are expensive or in limited supply. Furthermore, this type of prior art system requires a large amount of hardware, junctions and lines that require maintenance and can potentially fail. The nanosyringe as described herein minimizes the fluid path and reduces the relative number of junctions and lines that are required to operate a delivery system, as compared to the prior art illustrated in FIG. 15.

The nanosyringe as described in the present disclosure provides solutions to these challenges described above as well as other limitations of the prior art devices. Still further benefits of the nanosyringes of the present disclosure will be apparent to one of skill in the art upon reading the present description.

In some embodiments, the nanosyringe device as described by the present disclosure further comprises a support structure that holds the nanosyringe device components in proper alignment resulting in a single rigid unit.

In some embodiments, the dispense event is a non-contact dispense event. In other embodiments, the dispense event is a contact dispense event.

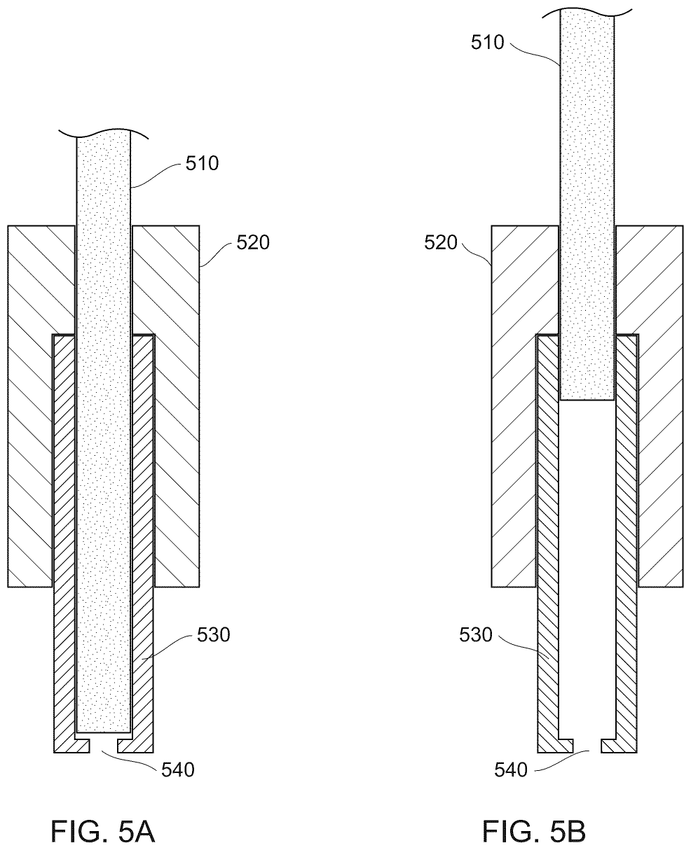

Typical operation of the nanosyringe device begins with the distal end of the nanosyringe elongated body, e.g., cylinder, containing the orifice immersed into a reservoir of the fluid to be dispensed. Aspects of this operation are illustrated in FIGS. 5A and 5B. The nanosyringe plunger 510 is initially fully inserted into the elongated body, e.g., cylinder, 530 (FIG. 5A), and in some embodiments, is in contact with the orifice plate or other terminal distal structure that covers the distal end of the elongated body, e.g., cylinder. The plunger 510 is then retracted by the linear actuator (FIG. 5B), thereby aspirating liquid into the nanosyringe central channel through the orifice 540. In some embodiments, the plunger 510 is retracted to a position that is approximately 90% of the length of the elongated body, e.g., cylinder, thereby taking advantage of nearly the full volume of the nanosyringe central channel. As shown in FIG. 58, the plunger 510 is withdrawn only to a point before complete removal from the central channel. This action aspirates the fluid through the orifice 540 and into the elongated body, e.g., cylinder. The extent to which the plunger is retracted from the elongated body, e.g., cylinder, is not limited, and it can be retracted to any degree. In some embodiments, the plunger is retracted only a small distance (e.g., any distance less than 90% of the length of the elongated body, e.g., cylinder, for example, between 5% and 50%) to aspirate smaller volumes.

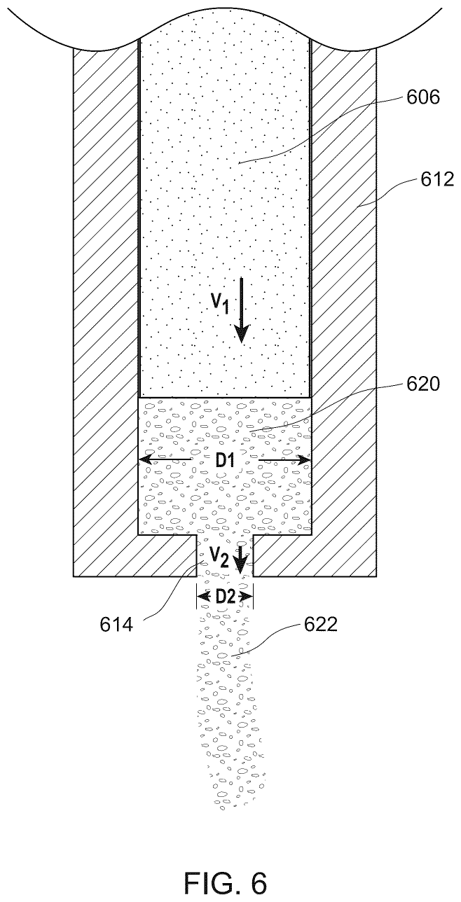

After aspirating the liquid, the distal end of the elongated body, e.g., cylinder, is removed from the dispense fluid reservoir (i.e., source reservoir) and placed over the container, vessel, well, glass slide or other flat surface or other destination to where the fluid is to be dispensed. The liquid in the elongated body, e.g., cylinder, now acts as the dispense fluid reservoir and the nanosyringe device acts as a positive displacement pump. See FIG. 6. The plunger 606 moves in the central channel toward the orifice at the distal end of the nanosyringe elongated body, e.g., cylinder, to sweep a volume equal to the desired dispense volume. In some embodiments, multiple dispense cycles are made from the single aspirated volume in the elongated body, e.g., cylinder.

In some embodiments, as shown in FIG. 6, the linear actuator shaft, and as a result the plunger 606, travels with a velocity V1. The plunger action can be characterized by a velocity V1, although the plunger velocity is not limited in any regard, and one of ordinary skill can readily determine a velocity or range of velocities that is optimized for the particular application for which they are employing the nanosyringe. In some aspects, it is significant to note that the linear actuator speed is set by the user using the software that controls the nanosyringe device. However, the speed of actual travel of the linear actuator shaft (and as a consequence, the plunger) may differ from the programmed speed, so measuring the actual speed of the shaft is a preferred method for system optimization.

For example, in some embodiments, V1 can be any value between 10 mm/sec and 1,000 mm/sec. In some embodiments, V1 can be any value between 50 mm/sec and 150 mm/sec. In some embodiments, V1 can be any value between 75 mm/sec and 125 mm/sec. In one embodiment, V1 can be about 100 mm/sec. The velocity of 100 mm/sec was the velocity of an actual plunger measured in a successful working example of the presently described nanosyringe liquid handler. This rate was measured experimentally using an ImageXpert Inc.® JetXpert Jr™ (formerly known as JetXpert OEM) inline droplet visualization and measurement platform.

By way of illustration, and as used in working EXAMPLE 8, the programmed speed was actually determined by a series of parameters entered by the user. In that example, the speed is initially a programmed Vstart, followed by V1, and ultimately reaching a Vmax setting of 66.5 mm/sec, with acceleration rate A1 of 4,768 mm/sec², motor current setting of 900 mA and motor microstep mode of 6400 microsteps per revolution.

The plunger action is also characterized by a rate of acceleration, the rate of acceleration of the plunger is not limited in any regard and any suitable value can be used. In various embodiments, the minimum acceleration of the plunger is 500 mm/sec² and the maximum acceleration of the plunger is 50,000 mm/sec². In some embodiments, the plunger has a rate of acceleration of any value between 1,000 mm/sec² and 20,000 mm/sec²′ such as between 2,000 mm/sec² and 15,000 mm/sec², e.g., between 4,000 to 10,000 mm/sec². In some embodiments, the plunger reaches a top speed at around 1 millisecond (ms) after the start of motion of the plunger, although faster and slower rates of acceleration also find use with the invention. For example, the top speed of the plunger can be reach at any time point between about 0.1 ms and 10 ms.

One of skill in the art will recognize that a range of velocity and acceleration values can find use with the liquid handler devices described herein, and additional velocities and acceleration rates can also be used.

The velocity and acceleration rate of the plunger forces the dispense fluid through the orifice. Because the orifice 614 has a diameter D2 that is smaller than the diameter D1 of the elongated body, e.g., cylinder, chamber, this results in an increase in the velocity (V2) of expelled liquid 622 as compared to the velocity of the plunger 606. The result is that a precise volume of fluid is ejected from the orifice of the nanosyringe elongated body, e.g., cylinder, into or onto whatever apparatus is being used to capture it. The dispense cycle can be repeated until the original volume of aspirated liquid is consumed by repeated dispense cycles. At this point, the aspiration of fluid into the central channel of the elongated body, e.g., cylinder, may be repeated if more dispense cycles are desired. The programmability of the linear actuator and its controls allow very small amounts of dispense fluid to be precisely aspirated and dispensed. This is a significant advantage over the present state of the art which requires many more components (for example, valves, pumps and reservoirs) to accomplish this same task.

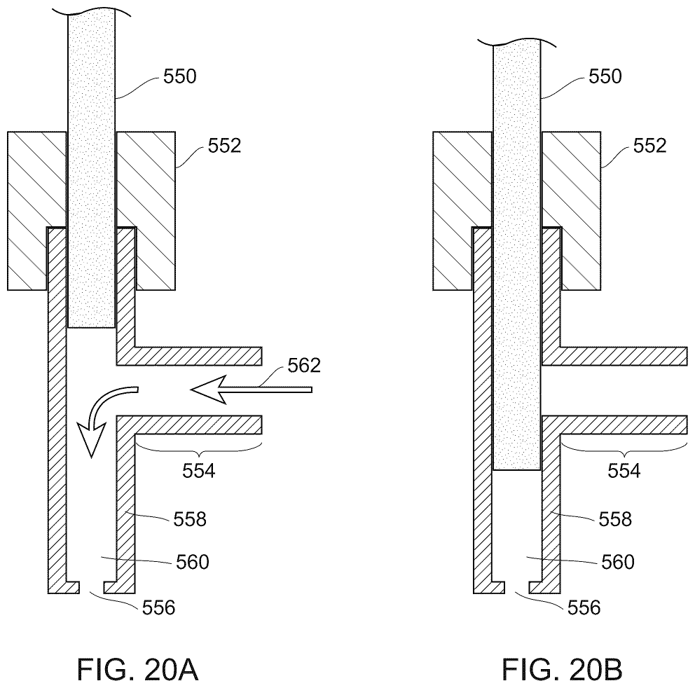

In other embodiments of the nanosyringe as described herein, a port can be installed in the side of the elongated body, e.g., cylinder, to add additional benefits and functionality to the nanosyringe device as described herein. This configuration is shown in the schematic of FIGS. 20A and 20B. The plunger 550 and seal 552 are shown. The port 554 can be installed at a position in the elongated body, e.g., cylinder, 558 that is closer to the proximal end of the elongated body, e.g., cylinder, than to the distal end of the elongated body, e.g., cylinder, where the proximal end of the elongated body, e.g., cylinder, is closest to the linear actuator shaft and the distal end of the elongated body, e.g., cylinder, is the end containing the orifice 556. Note in this schematic, the relative position in the distal end or proximal end in the elongated body, e.g., cylinder, is not reflected to scale. The inner diameter of the port can be the same diameter as the nanosyringe elongated body, e.g., cylinder, inner diameter (i.e., the nanosyringe central channel), or can be smaller or larger than the nanosyringe central channel.

This port increases the functionality of the nanosyringe device, where the device can act as a valve as well as a dispense device. When the plunger distal end extends below the port and covers the port (shown in FIG. 20B), the device operates as described above without any liquid input from the port into the central channel 560. If the distal end of the plunger is above the level of the port (shown in FIG. 20A), the port can now be used to introduce a fluid flow 562 into the elongated body, e.g., cylinder, as shown by the arrows in FIG. 20A, thereby aiding in flushing and rinsing contaminants or air from the elongated body, e.g., cylinder. In some embodiments, a vacuum can also be applied to the port to assist in removing any trapped air in the central channel of the elongated body, e.g., cylinder.

As described above, in a nanosyringe device, there is no working fluid between the pumping force (i.e., the linear actuator shaft) and the nanosyringe elongated body, e.g., cylinder. As a result, only the experimental fluids of interest are aspirated into and dispensed from the nanosyringe central channel of the elongated body, e.g., cylinder. This configuration has the advantage that there is no risk of mixing of the desired experimental fluid of interest with working fluid. Another advantage is that there can be more precise control of the dispensed volume, since the amount of fluid dispensed is directly related to the volume displaced by the plunger.

Non-limiting embodiments of the liquid handling devices described herein are illustrated in the appended drawings. In the following description, an embodiment of the nanosyringe is described in which the elongated body is a cylinder and the actuator is a linear actuator. However, the invention is not so limited, e.g., as described in greater detail below.

FIG. 1 provides a schematic of one embodiment of a nanosyringe 100 of the disclosure showing a coaxial alignment of the linear actuator shaft 114 and the nanosyringe cylinder plunger 150. In this configuration, the linear actuator shaft 114 and the nanosyringe cylinder plunger 150 share the same axis, that is to say, the axis of the linear actuator shaft 114 is the same as the axis of the nanosyringe plunger 150. The nanosyringe 100 of FIG. 1 is operated by the linear actuator motor 112 that is electronically coupled to a user interface for the user to program and control the action of the linear actuator 110. The linear actuator shaft 114 is operably coupled to the nanosyringe plunger 150 by a coupling 130. In this embodiment, the coupling 130 can take any form, and is not particularly limited with regard to design or materials, where the only requirement of the coupling is to provide a physical linkage between the linear actuator shaft 114 and the nanosyringe plunger 150, such that powered movement of the actuator shaft 114 results in corresponding movement of the nanosyringe plunger 150.

As shown in the embodiment of FIG. 1, the nanosyringe plunger 150 travels in the nanosyringe channel 124 within the nanosyringe cylinder 120. The nanosyringe plunger 150 and nanosyringe sidewalls 122 are manufactured to tight tolerances such that the plunger 150 controls the aspiration and dispensing of liquid into the nanosyringe cylinder channel 124 through the bottom orifice 126, characterized by a given aperture size. In some embodiments, the nanosyringe 100 incorporates a seal 140 encompassing the junction between the nanosyringe cylinder plunger 150 and the nanosyringe cylinder cylinder 120. The seal 140 can be any suitable material, including but not limited to Teflon™ (i.e., comprising polytetrafluoroethylene [PTFE]), Delrin® plastic, polyether ether ketone (PEEK), high strength slippery PEEK, Slippery Delrin Acetal AF Resin (Teflon blended with Delrin), or any other suitable material know to one of skill in the art. The seal can be in the form of an O-ring, or any other suitable geometry that encompasses the junction between the proximal end of the cylinder 120 and the plunger. The seal 140 provides a barrier that prevents the leakage of liquid from the nanosyringe cylinder 120. See for example FIGS. 5A and SB.

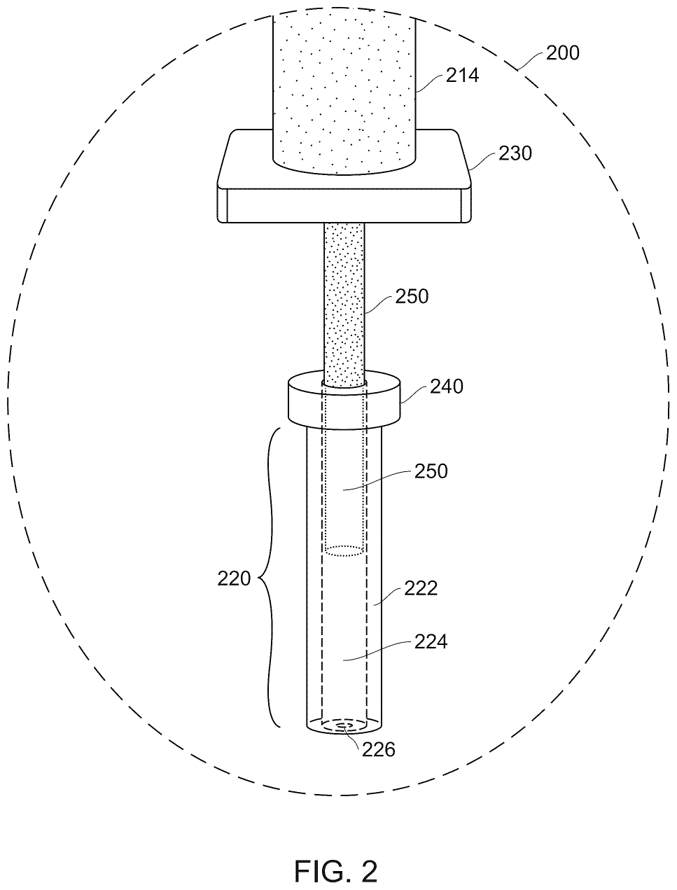

FIG. 2 shows an expanded view 200 of FIG. 1 area 102. As shown in FIG. 2, the linear actuator shaft 214 is coupled to the nanosyringe plunger 250 by a coupling 230. The nanosyringe plunger 250 travels in the nanosyringe channel 224 within the nanosyringe cylinder 220. The nanosyringe plunger 250 and nanosyringe sidewalls 222 are manufactured with suitable diameters such that the plunger 250 controls the aspiration and dispensing of liquid into and out from the nanosyringe cylinder channel 224 through the bottom orifice 226, characterized by a given aperture size. In some embodiments, the nanosyringe incorporates a seal 240 encompassing the junction between the nanosyringe plunger 250 and the nanosyringe cylinder 220. The seal can be any suitable material, e.g., Teflon™, although any suitable material can be used as described herein.

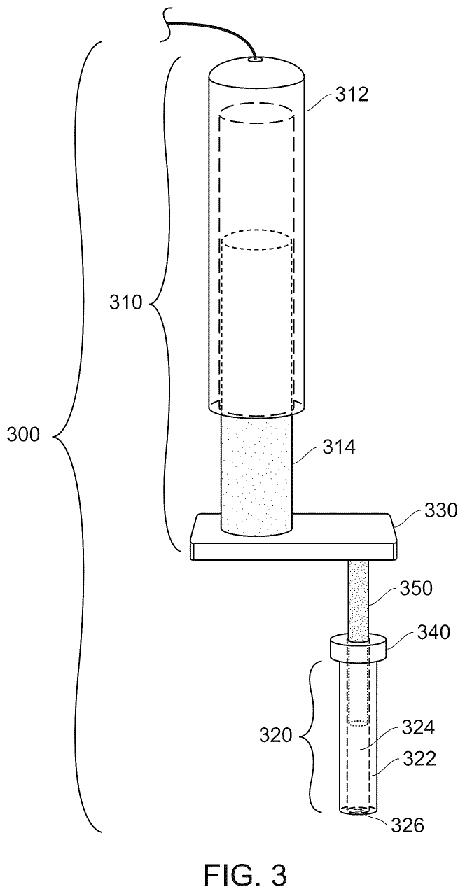

FIG. 3 shows an alternative embodiment of a nanosyringe 300 of the disclosure where the linear actuator shaft 314 and the nanosyringe cylinder plunger 350 are not coaxial in their arrangement (i.e., are non-coaxial). That is to say, the linear actuator shaft 314 and the nanosyringe cylinder plunger 350 do have the same axis of travel. The nanosyringe 300 is operated by the linear actuator motor 312 that is electronically coupled to the user interface for the user to control the action of the linear actuator 310. The linear actuator shaft 314 is coupled to the nanosyringe plunger 350 by a dogleg coupling 330. The dogleg coupling permits a non-coaxial alignment between the linear actuator 310 and the nanosyringe plunger 350 and cylinder 320. This configuration is useful because it allows for a compact arrangement of multiple nanosyringe cylinder units to form a nanosyringe array, finding use in the simultaneous liquid manipulation of multiwell systems.

As shown in FIG. 3, the nanosyringe plunger 350 travels in the nanosyringe channel 324 within the nanosyringe cylinder 320. The nanosyringe plunger 350 and nanosyringe sidewalls 322 are in contact and form a seal such that the plunger 350 controls the aspiration and dispensing of liquid into the nanosyringe cylinder channel 324 through the bottom orifice 326, characterized by a given aperture size. In some embodiments, the nanosyringe 300 incorporates a seal 340 encompassing the junction between the nanosyringe plunger 350 and the nanosyringe cylinder 320. The seal can be any suitable material, including but not limited to Teflon, Delrin® plastic, or any other suitable material described herein.

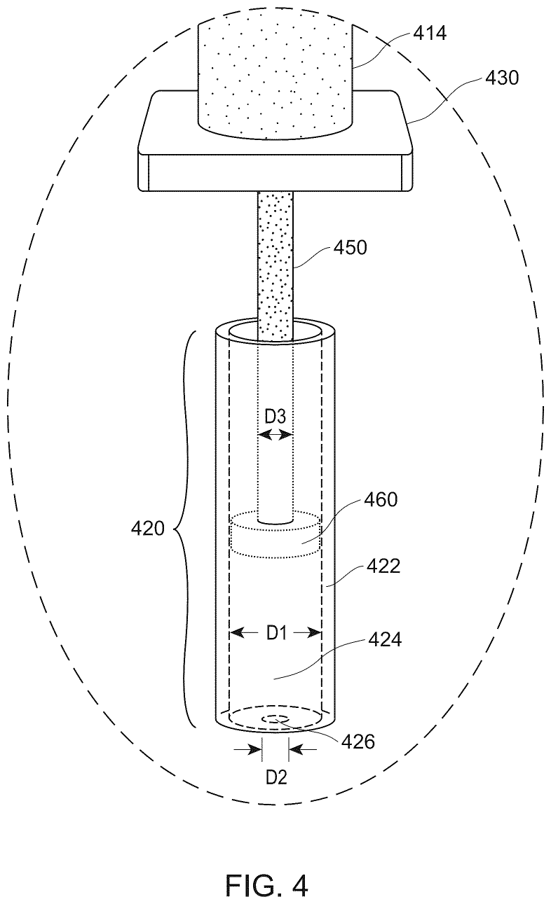

FIG. 4 describes another embodiment of the nanosyringe where the nanosyringe plunger 450 employs a plunger seal 460 at the distal end of the plunger 450. In this embodiment, the linear actuator shaft 414 is coupled to the nanosyringe plunger 450 by a coupling 430. The nanosyringe plunger 450 travels freely in the nanosyringe channel 424 within the nanosyringe cylinder 420. The nanosyringe plunger 450 and nanosyringe sidewalls 422 are manufactured with dimensions such that the plunger 450 diameter D3 is smaller than the nanosyringe cylinder channel 424 diameter D1. A plunger seal 460 is installed at the distal end of the plunger 450, where the plunger seal 460 and the walls of the nanosyringe channel 422 have a tight seal, e.g., where the diameter of the plunger seal 460 is not more than one mil smaller than the diameter of the cylinder channel 424. In this embodiment, the plunger is capable of aspirating and dispensing liquid through the orifice 426 having diameter D2, where the motion of the plunger 450 controls the motion of the liquid through the orifice 426.

FIGS. 5A and SB illustrate one embodiment of the action of a nanosyringe plunger. In these illustrations, the nanosyringe plunger 510 forms a tight junction with the sidewalls of the nanosyringe sidewalls 530, e.g., a junction equal to or less than about one thousandth of an inch. The portion of the structure where the plunger 510 enters the nanosyringe cylinder is surrounded by a seal 520 that aligns the plunger 510 and nanosyringe cylinder, and also prevents leakage of liquid that may leak from the plunger/nanosyringe cylinder junction. FIG. 5A shows the plunger 510 in the extended position where liquid has been dispensed from the nanosyringe cylinder through the orifice 540. FIG. 5B shows the plunger 510 in the withdrawn position leaving a void in the nanosyringe cylinder where liquid can be aspirated through the orifice 540 to occupy the nanosyringe channel. In some embodiments, the seal can take the form of a cap such as shown in structure 520. In other embodiments, a seal can take any suitable form, such as a smaller structure similar to an O-ring. In still other embodiments, the nanosyringe does not use any seal around the plunger/cylinder junction where the plunger is inserted into the cylinder.

FIG. 6 illustrates one embodiment of the nanosyringe as described herein. In this illustration, the plunger 606 is closely associated with the cylinder sidewall 612. For example, in some embodiments, the plunger is not more than about one mil in diameter smaller than the cylinder within which the plunger is situated. Having this close association between the plunger 606 and the sidewall 612 has an added benefit of reducing the dead volume of the nanosyringe device.

FIG. 6 illustrates the relationship between the relative velocities of the plunger 606 (with velocity V1) and the liquid 622 emerging from the orifice 614 (with velocity V2), and the effect of the differing diameters of the nanosyringe channel 620 characterized by diameter D1 and the diameter of the orifice 614 characterized by diameter D2. Generally, V2 can be characterized by a ratio of D1:D2, where ratios of higher value indicate faster V2. That is to say, as D2 is smaller relative to D1, the value of V2 increases.

The nanosyringe can be designed to have any desired liquid dispense velocity V2. In some embodiments, a preferred dispense velocity is about 3 m/sec to about 5 m/sec. In other embodiments, a range of preferred dispense velocities is about 1 m/sec to about 10 m/sec.

A preferred liquid dispense velocity V2 for contactless dispensing is a velocity that is fast enough, that is to say has a minimum dispense speed, to cleanly deliver the dispensed liquid into a receiving well without leaving a hanging drop or other liquid volume in the vicinity of the orifice or otherwise clinging to the nanosyringe cylinder exterior surface. A preferred dispense velocity for contactless dispensing is a velocity that is not excessively fast such that the dispensed liquid will spray from the orifice or splash around or out of the receiving well and contaminate surrounding wells.

The diameter of the nanosyringe channel D1 is larger than the diameter of the orifice D2, thereby accelerating the rate of liquid dispense through the orifice 614 as compared to the downward velocity of the nanosyringe plunger. That is to say, the velocity of the liquid dispense V2 will always be greater than the velocity of the downward plunger action V1. The liquid dispense velocity V2 can be adjusted by changing the ratio of the width D2 of the orifice 614 to the width D1 of the cylinder channel 620 and/or by changing the velocity V1 of the downward action of the plunger 606.

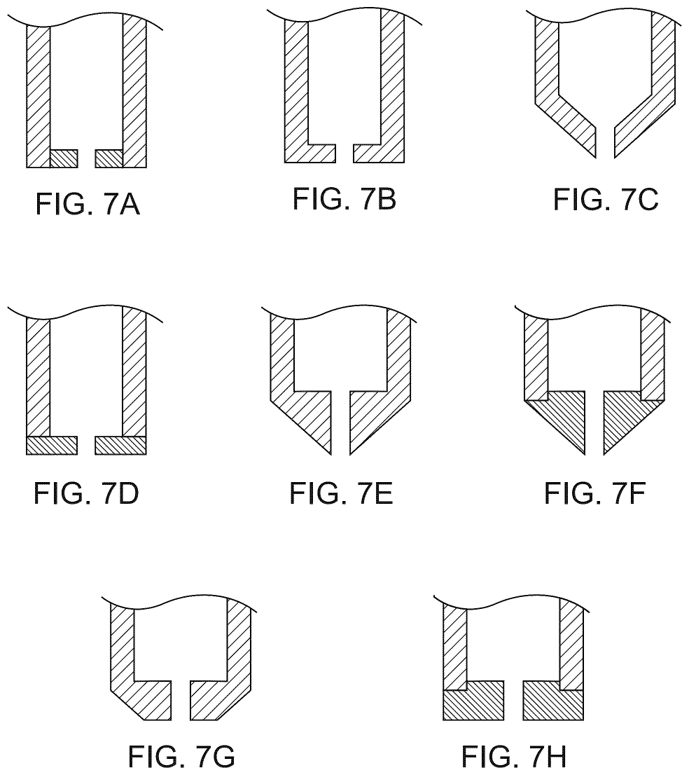

FIGS. 7A-7H show embodiments for designs for the distal ends of nanosyringe cylinders that find use with the devices as described herein. Various configurations for the most distal end of the nanosyringe cylinder containing the orifice can be used. In some aspects, the orifice is machined from the nanosyringe cylinder material, for example stainless steel, such that the orifice is an integral component of the cylinder and formed from the cylinder. Examples of this integrated orifice configuration are shown, for example, in FIGS. 7B, 7C, 7E and 7G.

In other embodiments, the distal end of the nanosyringe cylinder is capped by a secondary structure that contains the orifice. As used herein, the expression “orifice plate” refers to a structure that is attached to the distal-most portion of the nanosyringe cylinder, and in that embodiment, the orifice resides in the orifice plate. Nonlimiting examples of orifice plates are shown, for example, in FIGS. 7A, 7D, 7F and 7H.

The orifice plates can be attached to the nanosyringe cylinder by any suitable means, for example, press fit, swaged, welded, machined, or attached by epoxy adhesive or any other suitable adhesive, into or onto the nanosyringe cylinder.

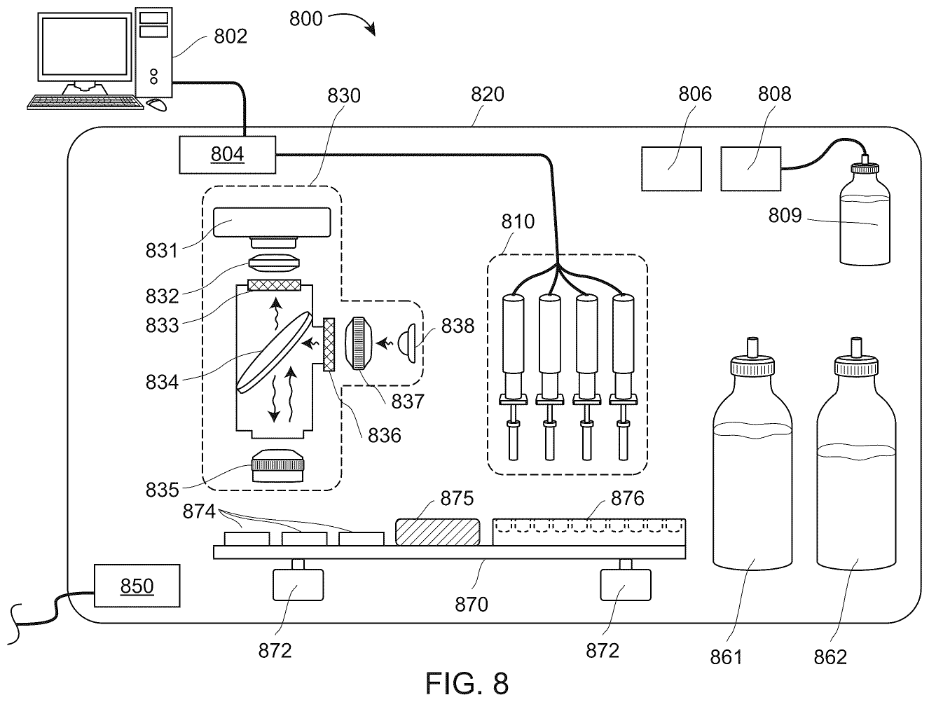

FIG. 8 shows a schematic depicting one embodiment of a system comprising an apparatus for liquid handling as described herein, capable of both liquid aspiration and liquid dispensing. The relative positions and sizes of the various components as shown in FIG. 8 are not fixed, are not to scale, and are intended only to provide a generalized scheme of one embodiment of a liquid handling apparatus. One of skill in the art will recognize that the components of the apparatus 800 described herein can assume any of a variety of configurations. Furthermore, one of skill in the art will also recognize that not all of the components shown in the embodiment 800 are required to construct an operable apparatus for liquid dispensing, and in other embodiments, still additional components not shown in FIG. 8 can be incorporated into the apparatus. The apparatus 800 depicted in FIG. 8 is not intended to be limiting in any aspects, except for the presence of at least one, and preferably a plurality, of nanosyringes as described herein.

Working examples of this apparatus consistent with this schematic in FIG. 8 have been constructed, and furthermore, these apparatuses were tested and function successfully as described herein.

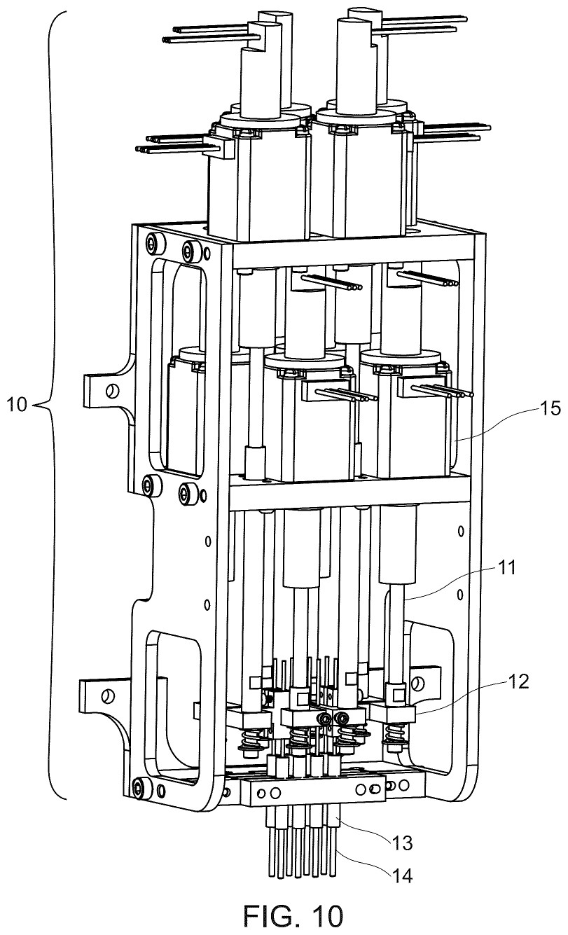

Minimally, the liquid dispensing apparatus 800 incorporates at least one, and preferably a plurality, of nanosyringes, the plurality of which is termed a nanosyringe array 810, as described in the present disclosure. Various embodiments of nanosyringe arrays incorporate any plurality of nanosyringes, for example, at least 4, 8, 10, 12, 20, 24 or 48 individual nanosyringes. One of skill in the art will recognize that the nanosyringes in a nanosyringe array will require a stabilizing framework to secure and properly align the nanosyringes in the apparatus. Examples of this framework are visible, for example, in FIGS. 10, 11 and 12. One of skill appreciates that any suitable framework can be constructed to house and support the plurality of nanosyringes in a nanosyringe array, and also recognizes that the invention is not limited to any particular design for a supporting structural framework. The apparatus also incorporates a power supply 850.

The liquid handling apparatus described herein is designed to aspirate and dispense liquid samples in a highly parallel and automated manner, and also optionally incorporate optical imaging hardware to facilitate the highly parallel and automated processing of multiple samples, such as is desired in the highly parallel processing of, for example, single cell samples, or highly parallel biochemical reactions, such as highly parallel nucleic acid analysis such as nucleic acid cloning, amplification and sequencing.

In some embodiments, the nanosyringe array 810 is fixed in one location in the x/y plane within the liquid dispensing apparatus 800, and the various source plates 876, waste or wash stations 874 and dispensing destinations 875 reside on a stage 870 that moves in the x/y plane underneath the nanosyringe array 810. The nanosyringe array 810 is capable of movement in the Z dimension (i.e., vertically) so that the nanosyringe cylinder distal end can be raised and lowered in the various liquids in order to aspirate liquids from the various sample source plates, wash troughs for rinsing, and for setting a suitable height for dispensing.

In some embodiments, the liquid handling apparatus 800 comprises a computer control system that further comprises a user interface 802. The computer control system can be part of the liquid handling apparatus, or it can be an external computer. This computer control system can house any software required to operate the liquid dispensing apparatus and any of the hardware associated with the apparatus, for example, the camera assembly 830, cooling unit 806, humidifier 808, and motors 872 that translocate the movable stage 870 underneath the nanosyringe array 810 in the x/y plane.

In some embodiments, the computer module 802 comprising the software and user interface can be integrated into the apparatus, for example, so that a user interface is displayed on or within or otherwise attached to the housing 820 of the instrument, or at a dedicated workstation. In some embodiments, the apparatus 800 comprises one or more internal computer modules 804 that control or distribute signals to components of the apparatus.

Software that controls the liquid handling apparatus allows the user to program any desired sequence and pattern of liquid handling, including aspiration steps, dispensing steps, washing and rinsing steps, and can program any of these steps to occur at any addressable location on a destination surface, for example, in the wells of a multi-well device, such as a multi-well chip or source reservoir plate.

In some embodiments, the liquid handling apparatus comprises a housing 820, within which is contained all or a subset of the components of the apparatus. The housing can be any shape, design or material, and is not particularly limited. In some embodiments, the housing serves to create a sufficiently sealed chamber so that the environment inside the housing can be controlled, for example, in temperature, humidity or gaseous content. That is to say, the housing can create an environmentally-controlled environment.

The apparatus will comprise a destination for the liquid delivery. In some embodiments, this destination is most often a multi-well device, e.g., plate or chip, comprising fluidically isolated, i.e., physically separated, wells or other chambers, where each well can contain an isolated liquid volume that does not mix with any other well on the plate or chip.

In some embodiments, the apparatus includes a cooling/heating unit 806, for example, a thermoelectric cooling unit (TEC), i.e., a solid-state heat pump that requires a heat exchanger to dissipate heat utilizing the Peltier Effect. In some embodiments, the TEC can reside below the multi-well device 875 (e.g., plate or chip). In other embodiments, the TEC can reside under or integrated within the movable stage 870, and thereby provide cooling not only to the receiving multi-well device, e.g., chip, but also any source plates, e.g., source reservoir plates or other reagents that are located on the movable stage 870. In other embodiments, the cooling mechanism can be other than a TEC heat exchanger unit and can be positioned at any other location in the apparatus. The device may have one or more TEC units as desired by the user.

In some embodiments, the apparatus comprises a humidifier 808 that humidifies the interior of the apparatus when a sealed environment is created by a suitable housing 820. The humidifier can be operably and fluidically coupled to a humidifier water supply 809. Humidifying the interior of the apparatus is advantageous in order to minimize evaporative loss of the very small volumes of liquid that are dispensed by the nanosyringes into any suitable wells in a multi-well device, e.g., plate or chip.

In some embodiments, the apparatus incorporates a camera assembly 830 for imaging plates or chips that are contained in the apparatus. The camera assembly minimally includes a camera 831, and variously further includes at least one objective lens 832 (e.g., a 2× objective lens), emission filters 833, a dichroic filter 834, a secondary focus objective lens 835 (e.g., a 4× objective lens), excitation filers 836 (e.g., an epifluorescence filter set), a focus lens 837 and a light source (e.g., an LED light source) 838.

As shown in FIG. 8, in some embodiments, the apparatus can also incorporate one or a plurality of fluid reservoirs, such as a first fluid reservoir 861 and a second fluid reservoir 862. The fluid reservoirs can contain the liquids used in the washing/rinsing and disinfecting steps, for example, can contain liquids such as water, 0.2% bleach or alcohol solutions or similar liquids that are used by the nanosyringes for cleaning and disinfecting. The fluid reservoirs can be fluidically coupled to a wash station 874, where liquid from a fluid reservoir 861/862 is delivered and continuously supplied as necessary to a wash station 874. The nanosyringes in the nanosyringe array 810 can aspirate a wash solution or disinfecting solution from a wash station 874 and dispense that liquid into a suitable waste station before proceeding to the next sample delivery or source plate. In some embodiments, liquid in the fluid reservoirs 861/862 is delivered to the wash station 874 through suitable tubing where the flow of the liquid is driven by any type of suitable pump, for example, a peristaltic pump.

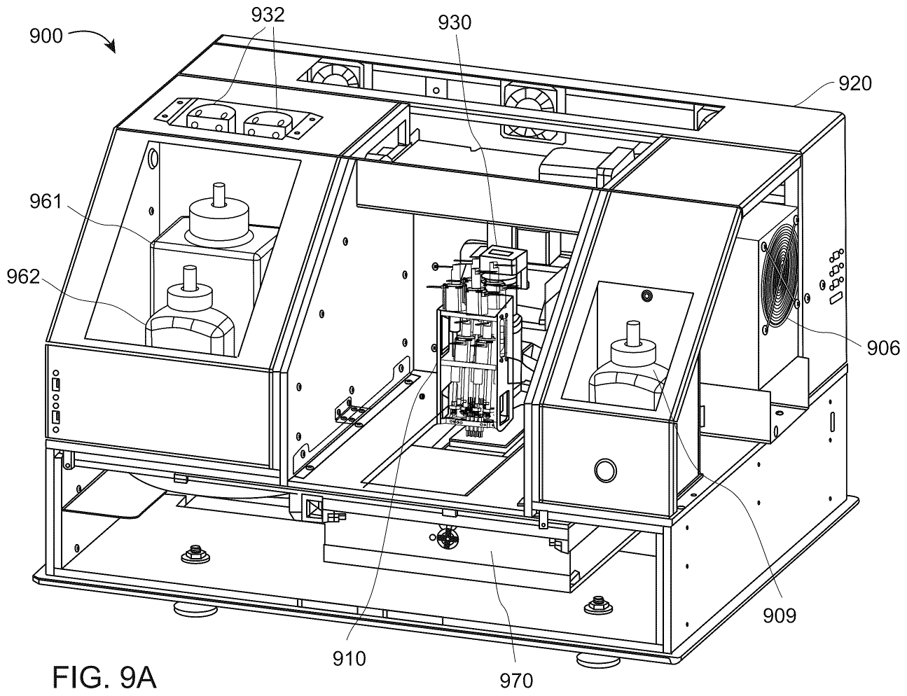

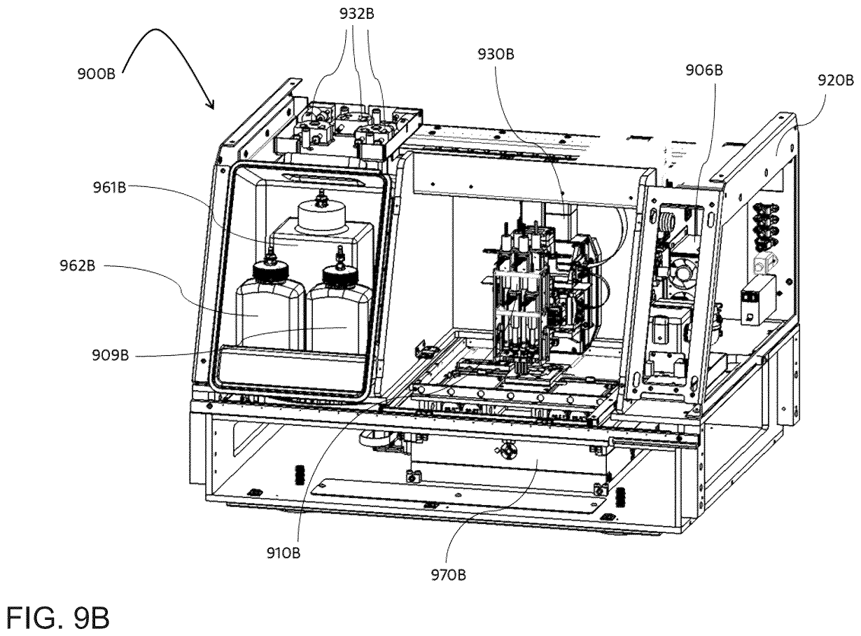

FIG. 9A provides an engineering schematic of a fully operable working model of a liquid handling apparatus 900 according to an embodiment described in the present disclosure. Components of this engineering schematic include the housing 920, nanosyringe array 910 and the structural framework surrounding the nanosyringe array; the movable stage 970 with an integrated Peltier controller for heating and cooling; humidifier water supply 909; camera assembly 930; first and second fluid reservoirs 961/962, for the delivery of, e.g., water, a bleach solution (e.g., 0.2% bleach) or alcohol, to the proper wash station. The schematic also shows peristaltic pumps 932 for the delivery of the fluid reservoirs 961/962 to the appropriate wash station. A cooling unit 906, e.g., a thermoelectric cooler unit (TEC), is also shown.

FIG. 9B provides an engineering schematic of an alternative fully operable working model of a liquid handling apparatus 900B according to an embodiment described in the present disclosure. Components of this engineering schematic include the housing 920B, nanosyringe array 910B and the structural framework surrounding the nanosyringe array; the movable stage 970B with an integrated Peltier controller for heating and cooling; humidifier water supply 9098; camera assembly 930B; first and second fluid reservoirs 961B/962B, for the delivery of, e.g., water, a bleach solution (e.g., 0.2% bleach) or alcohol, to the proper wash station. The schematic also shows peristaltic pumps 932B for the delivery of the fluid reservoirs 961B/962B to the appropriate wash station and for the humidifier water supply 909B. In this embodiment, the cooling unit has been replaced with a dehumidifier 906B.

FIG. 10 provides an engineering schematic showing a nanosyringe array 10 as is used in a liquid handling apparatus as described in the present disclosure. Also shown in this schematic is the structural scaffolding that secures and aligns the nanosyringes in the apparatus. The nanosyringe array shown in this particular embodiment incorporates eight individual nanosyringes. FIG. 10 shows the component's linear actuator motor 15, linear actuator shaft 11, coupling 12, which in the present embodiment is a dogleg coupling, a seal 13 (e.g., a Teflon seal) surrounding the nanosyringe cylinder and plunger junction, and the nanosyringe cylinders 14.

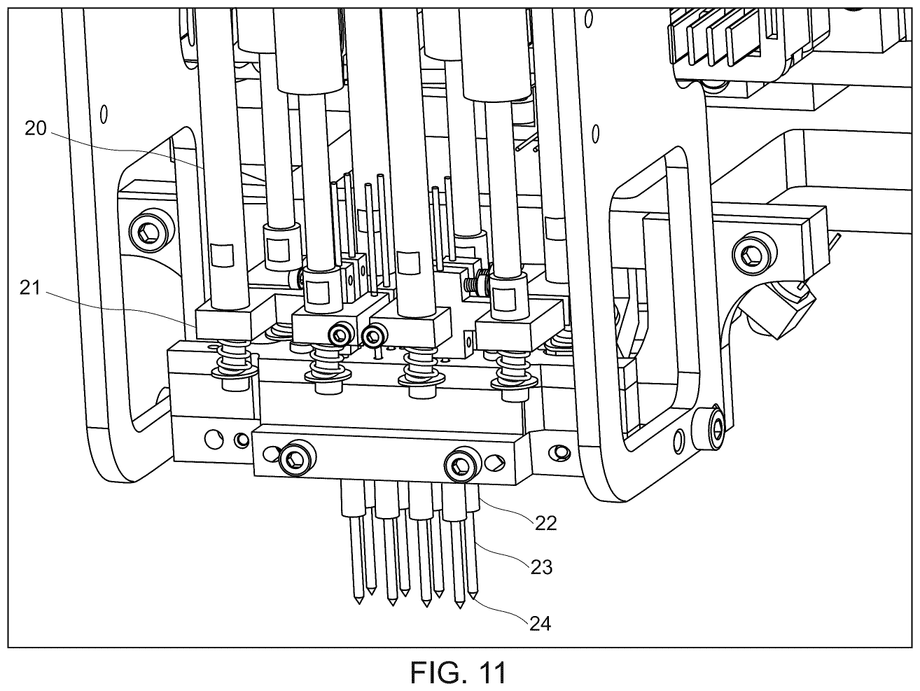

FIG. 11 also provides an engineering schematic showing a portion of a nanosyringe array as used in a liquid handling apparatus as described in the present disclosure. Also visible in this schematic is the structural scaffolding that secures and aligns the nanosyringes in the apparatus. The nanosyringe array shown in this particular embodiment incorporates eight individual nanosyringes. FIG. 11 shows the linear actuator shafts 20, the coupling 21, which in the present embodiment is a dogleg coupling, the seal 22 surrounding the nanosyringe cylinder and plunger junction, the nanosyringe cylinder 23 and the nanosyringe cylinder distal ends 24.

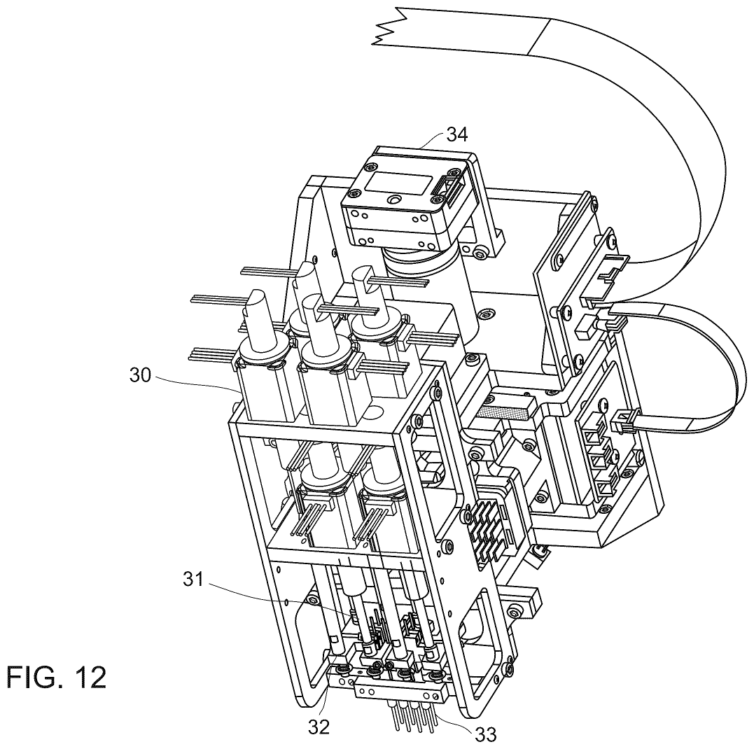

FIG. 12 provides another engineering schematic showing a nanosyringe array and other components as used in a liquid handling apparatus as described in the present disclosure. The structural scaffolding that secures and aligns the nanosyringes in the apparatus is also visible. The nanosyringe array shown in this particular embodiment incorporates eight individual nanosyringes. Shown in the figure are the linear actuator motors 30, linear actuator shafts 31, dogleg couplings 32 and nanosyringe cylinders 33. Also visible is the camera assembly 34.

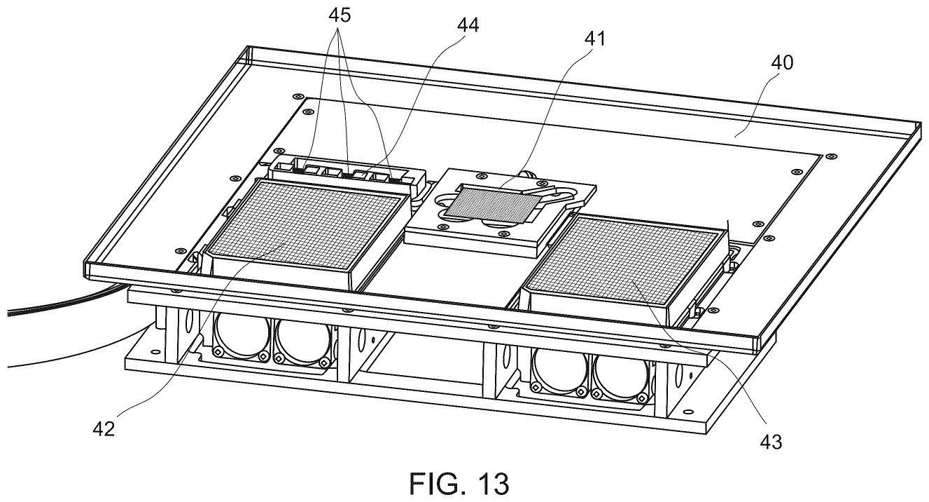

FIG. 13 provides an engineering schematic showing a portion of an apparatus for liquid handling as described in the present disclosure. This figure shows the movable stage 40, and components that are coupled to that movable stage. In some embodiments, the movable stage comprises an integrated Peltier controller for heating and cooling. Shown in the figure are a multi-well device, e.g., chip, 41 into which sample and/or reagents are delivered by the nanosyringe. A first source plate 42 and a second source plate 43 are shown. In some embodiments, a source plate comprises 384 wells, which can either function as a sample source plate or a reagent source plate. These source plates may be referred to as source reservoir plates, each including 384 reservoirs In some embodiments, reagents from the source plates are delivered to the wells of the multi-well device, e.g., chip. Wash troughs 45 are shown, which can contain, e.g., water, bleach or alcohol, or the like, which can be used for washing and/or disinfecting the nanosyringes. Waste trough 44 is shown for dispensing unused reagents from the nanosyringes and/or expelling washing or disinfecting liquids after the washing process.

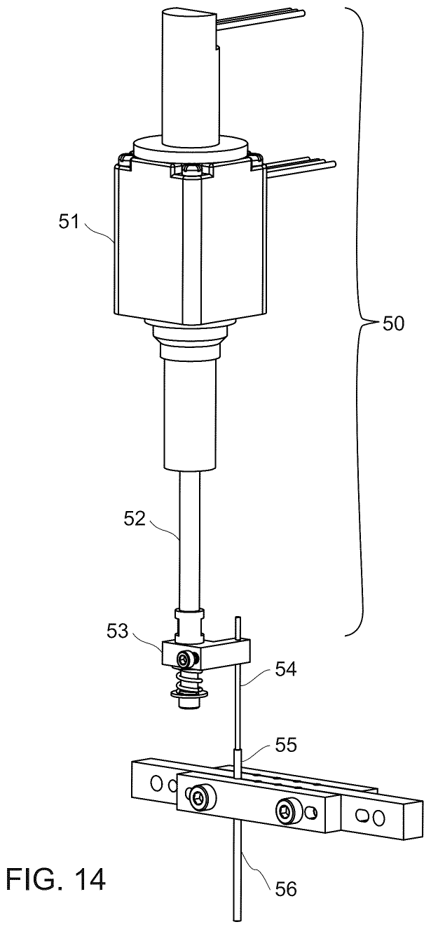

FIG. 14 shows a detailed rendering of a single nanosyringe as used in a nanosyringe array employed in a liquid handling apparatus as described herein. A linear actuator 50 is shown, consisting of a linear actuator motor 51 and a linear actuator shaft 52. The linear actuator shaft is functionally coupled to the nanosyringe plunger 54 by a dogleg coupling 53. The dogleg coupling 53 results in a configuration where the axis of the linear actuator shaft and the nanosyringe cylinder 56 (and the nanosyringe plunger that is situated in the cylinder) are laterally translocated and therefor do not have a coaxial orientation. However, the linear actuator shaft 52 and the nanosyringe plunger 54 are mechanically coupled, where a vertical motion of the linear actuator shaft 52 is immediately translated to a motion of the nanosyringe plunger 54 equal in magnitude to the motion of the linear actuator shaft 52, but translocated in a different axis of movement.

Aspects of the nanosyringes are discussed below.

### I. Actuator

The nanosyringe devices of the present disclosure incorporate an actuator as described herein. The type and model of actuator used with the devices described herein is not particularly limited. Actuators are components configured to move the plunger, e.g., in the central channel, in a manner sufficient to aspirate and/or dispense liquid therefrom, as desired. Actuators are known in the art, and one of ordinary skill in the art will recognize that many different actuators can find use with the devices described herein.

In some embodiments, the actuator is a linear actuator. Linear actuators include a motor and a movable shaft that is driven by the motor, where the shaft moves along a single axis, that is to say, in a straight line. Various types of linear actuators are known in the art, including but not limited to mechanical actuators, including screw type actuators. In some embodiments, linear actuators are stepper motors that incorporate a lead screw as the rotor, which translates motor torque into linear thrust.

Some mechanical linear actuators are capable of only pulling or only pushing; linear actuators used with the devices described herein are capable of generating force in both directions.

Other types of linear actuators that can find use with the nanosyringes described herein include, for example but are not limited to, hydraulic actuators, pneumatic actuators, piezoelectric actuators, electromechanical actuators, telescoping linear actuators and linear motor actuators.

In some embodiments, the actuator, e.g., the linear actuator, used in the present nanosyringe devices is capable of high speeds and high accelerations and have motion resolution in the micron range. The actuator can be driven by a stepper motor, as in the present embodiment, or can be servo driven by a DC motor or voice coil motor. The high speed and acceleration are required to provide non-contact dispensing and the precise motion resolution to provide accurate dispense volumes in the nanoliter range.

In one embodiment, and successfully utilized in a working example of the device, eight (8) NEMA Size 8 hybrid stepper motor linear actuators (DINGS' MOTION USA™, Morgan Hill, CA) were used to form a nanosyringe array. These linear actuators have a compact footprint of 20 mm, travel range of 25.4 mm, and maximum speed of 100 mm/second.

The speed of the linear actuator shaft, and as a result the speed of the plunger that travels in the cylinder channel, is controllable and can be selected from a variety of values. Furthermore, in some embodiments, the speed of the plunger can be modulated using a multiphasic profile during different phases of the aspiration phase or the dispense phase. For example, and as used herein with the nanosyringes described by the present disclosure, the speed and acceleration of the linear actuator shaft (and the plunger) are controlled by the TRINAMIC (Hamburg, Germany) SixPoint™ motion controller ramp generator that offers faster machine operation compared to the classical linear acceleration ramping cycles. The SixPoint™ ramp generator allows adapting the acceleration ramps to the torque curves of a stepper motor. It uses two different acceleration settings for the acceleration phase and also two different deceleration settings for the deceleration phase. Start and stop speeds greater than zero can also be used.

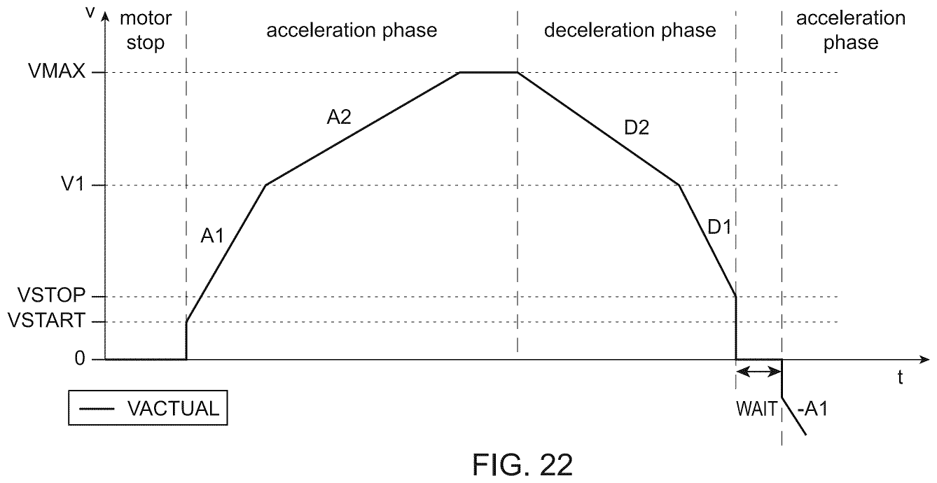

Aspects of this speed control program are shown in FIG. 22. The six-point ramp program begins using the start speed VSTART (which can also be zero). Then, the acceleration value A1 will be used to accelerate the motor to the speed V1. When the speed V1 has been reached, the motor will be further accelerated using the acceleration value A2 until it has reached the speed VMAX. The deceleration phase begins using the deceleration value D2. After reaching the speed V1 again the deceleration value D2 will be used to decelerate to the stop speed VSTOP (which can also be zero).

### II. Nanosyringe Elongated Body and Plunger

The nanosyringe devices described herein incorporate a nanosyringe elongated body. The elongated body includes a central channel, which central channel is configured to house a volume of liquid to be aspirated and/or dispensed. The elongated body is a structure having a length that is longer than its width, where the dimensions of the elongated body may vary. In some instances, the length of the elongated body may range from 10 to 100 mm, such as 20 to 50 mm, and the outside width or outside diameter of the elongated body may range from 0.5 to 10 mm, such as 1 to 5 mm. The elongated body may have any convenient configuration, where configurations of interest include, but are not limited to, configurations where the cross-sectional shape is a circular, e.g., a circle, an oval, etc. In some embodiments the elongated body may be configured to have a cross-sectional shape that is polygonal, e.g., a rectangle, a square, etc. The elongated body may have a uniform or varying external configuration. As such, in some instances, the elongated body may have a constant width along the length of the elongated body. In other instances, the width of the elongated body may vary along the length of the elongated body. As such, in some instances, where width may be referred to as the outer diameter (e.g., where the elongated body is configured as cylinder) the outer diameter of the elongated body may be constant along the length of the elongated body, while in other instances the outer diameter may vary along the length of the elongated body.

In some instances, the elongated body is a cylinder. See FIG. 2. The cylinder 220 includes the nanosyringe cylinder sidewall 222 and a central channel 224 that runs the length of the cylinder. At the distal end of the cylinder, there is an orifice 226 through which the aspirated/dispensed liquids pass.

In some embodiments, the cylinder is typically a stainless-steel hypodermic-style tube or a glass capillary, although in other embodiments the cylinder is machined, i.e., milled, from a stainless steel cylinder to form the steel cylinder used in that nanosyringe.

In some embodiments, the cylinder has an initial internal diameter that is less than a desired target internal diameter, such as 0.5 mil smaller than the desired target internal diameter. By way of example if the target internal diameter is 34 mil, cylinders with an internal diameter of approximately 33.5 mil are obtained. The internal diameter is then widened to the desired target internal diameter, e.g., via using a reamer.

In some embodiments, the inner diameter of cylinder channel is approximately 0.8 mm and the limit on the length of the cylinder is determined by the stroke length of the linear actuator used. In some embodiments, the stroke length is approximately 25 mm.

In the nanosyringes as described herein, a plunger 250 sits in the nanosyringe cylinder channel 224. In some embodiments, the plunger is a stainless-steel rod nearly the same diameter as the inner diameter of the cylinder channel (e.g., not more than about 1 mil smaller than the cylinder channel diameter) to ensure a tight fit between the plunger and cylinder sidewall 222.

In some embodiments, the plunger is longer than the cylinder so that the plunger will reach to the orifice at the distal end of the cylinder. See FIG. 5A. In other embodiments, the opposite end (i.e., the proximal end) of the plunger makes a mechanical/physical connection to the coupling, which in turn is coupled to the shaft of the linear actuator. This coupling between the linear actuator shaft and the plunger can utilize any suitable mechanical/physical coupling and is not particularly limited in how the mechanical/physical coupling is made.

In some embodiments, the linear actuator shaft and the nanosyringe cylinder are aligned along the same axis, in a coaxial configuration, i.e., are colinear. See for example FIG. 1. In other embodiments, the linear actuator shaft and the nanosyringe cylinder are laterally displaced, so that the linear actuator shaft and the nanosyringe plunger are not coaxial in configuration. See FIG. 3. In this configuration, the linear actuator shaft and the nanosyringe plunger have a different axis of travel, but they are synchronized in their vertical movement through the coupling 330. As used herein, the off-set coupling, i.e., a coupling that results in lateral displacement of the two adjoined parts, is termed a “dogleg coupling.”

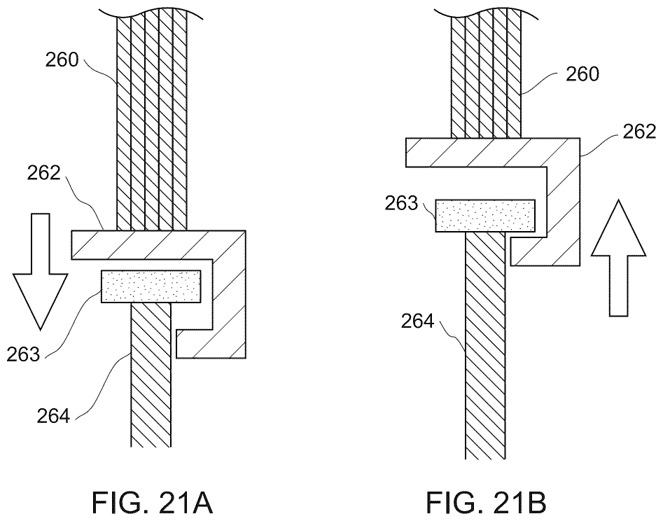

In other embodiments, as shown in FIGS. 21A and 21B, additional configurations for a coupling between the linear actuator shaft and the plunger are contemplated. In these embodiments, a coupling is used that does not make a permanent physical joining of the linear actuator shaft 260 and the plunger 264, but permits transient contact while the linear actuator 260 is either retracting (aspirating; FIG. 21B) or extending (dispensing; FIG. 21A). In one embodiment, using this configuration, the plunger 264 also comprises a lip or overhang structure 263 at the proximal end of the plunger 264 which allows the linear actuator shaft 260 to grab and retract the plunger 264 from the nanosyringe cylinder channel. Using this configuration, the coupling 262 can act as a hammer on the top of the plunger. This configuration has the benefit of a much more rapid acceleration of the plunger at the dispense step, thereby reducing any chance of hanging or clinging liquid following the dispense event. In some aspects, this configuration may have additional benefits by relaxing the strict requirement for alignment between the linear actuator shaft, the plunger and nanosyringe cylinder.

In one embodiment, and successfully utilized in a working example of the nanosyringe device, eight (8) nanosyringes were constructed from stainless steel tubes having an orifice at one end. The plungers used in these cylinders were stainless steel rods. The nanosyringe cylinders had a volume capacity of 12 μL (i.e., 12,000 nL). The stroke length was 24 mm and the cylinder had a dead volume of <0.4 μL (i.e., 400 nL). As used herein, this dead volume refers to the volume of fluid remaining inside the cylinder when the plunger is depressed to the lowest position (touching the distal end cylinder). This includes the volume of liquid that remains in the orifice, distal end of the cylinder and between the inner wall of the cylinder and the OD of the plunger. A range of plunger diameters (e.g., 31-34 mils) and cylinder channel diameters (i.e., the cylinder inner diameter) have been successfully tested. In some embodiments, the dimensions of the plunger diameter and the cylinder channel are paired so that there is a maximum of 1 mil difference between the nanosyringe cylinder channel diameter and the nanosyringe plunger diameter. However, one of skill in the art will recognize that the designs of liquid handlers described herein are not limited to these dimensions.

In still other aspects, as shown in FIG. 4, the nanosyringe cylinder and plunger can be configured where the plunger 450 has a shaft diameter D3 that travels freely in the nanosyringe cylinder channel that has a diameter D1, and where the plunger includes a distal flexible seal 460 on its outer diameter where the diameter of the distal flexible seal 460 is nearly identical to the nanosyringe cylinder channel diameter D1. For example, if the cylinder diameter D1 is about 33 mil, the plunger shaft 450 that is connected to the plunger seal 460 can be about 25 mil, although any value smaller than the diameter of the plunger seal can be used, for example, between about 25 and 29 mil.

The distal plunger seal 460 can be made of any suitable material that can form a tight junction with the sidewalls of the nanosyringe cylinder. Suitable materials include, but are not limited to, Teflon, Delrin, PEEK, and some composite materials such as high strength slippery PEEK (which contains Teflon, graphite, and carbon), and Slippery Delrin Acetal AF Resin (Teflon blended with Delrin). Ceramic or sapphire plunger seals also find use with the present devices described herein.

### III. Seal

The devices as described herein can optionally include a seal encompassing the junction between the nanosyringe cylinder and the nanosyringe plunger. This seal can prevent or reduce the loss of any liquid being aspirated or dispensed from the nanosyringe.

One embodiment of such a seal is illustrated in FIG. 2. As shown in that figure, the seal 240 encompasses the junction between the nanosyringe cylinder 220 and the syringe plunger 250. FIGS. 5A and 5B show an alternative embodiment of a seal 520 that can be used to construct a leak-proof junction or reduce liquid loss between the nanosyringe cylinder 530 and the plunger 510.

The length of the seal in not limited in any regard and can encompass either smaller or larger portions of the cylinder/plunger junction. In some embodiments the seal has an O-ring type of structure or it can be a longer structure that encompasses a larger area. In some embodiments, there is an advantage in having a shorter seal in contrast to a larger seal in that the larger seal results in greater friction between the plunger and surrounding seal material, and may impact the accuracy of the dispense or aspiration events.

The seal can be any suitable material, including but not limited to Teflon™, Delrin® plastic, poly ether ether ketone (PEEK), and composite materials such as high strength slippery PEEK (which contains Teflon™, graphite, and carbon), and Slippery Delrin Acetal AF Resin (Teflon™ blended with Delrin®)

In some embodiments, a seal is not required at the junction between the nanosyringe cylinder and the plunger.

### IV. Elongated Body Geometries, Orifice and Orifice Plate

In some embodiments, the orifice dimensions and the configuration of the distal end of the elongated bodies, e.g., cylinders, are key in achieving accurate and clean dispense events from the nanosyringe. Various features can be optimized to this end. As shown in FIG. 6, a preferred minimum liquid dispense velocity V2 for contactless dispensing is a velocity that is fast enough to cleanly deliver the dispensed liquid 622 into a receiving well without leaving a hanging drop in the vicinity of the orifice 614. Conversely, a preferred maximum dispense velocity V2 must be a speed that does not result in the dispensed liquid spraying from the orifice or splashing resulting in the contamination of surrounding wells. In some embodiments, but without limitation, a preferred velocity V2 is about 3-5 m/sec, although one of skill in the art will recognize that a much broader range of dispense velocities also can find use with the devices described herein.

In some embodiments, the distal end of the elongated body, e.g., cylinder, in the nanosyringe is capped with an orifice plate. As used herein, the term “orifice plate” is a separate piece that is machined with an orifice and is joined to the cylinder in a separate step. In various embodiments, the orifice plate is attached by welding to the cylinder, or alternatively, swaging, or press fitting or gluing. In some embodiments, the devices described herein do not use an orifice plate when the elongated body, e.g., cylinder, is fully machined, including the orifice, from one piece of material (i.e., drilling a blind hole and then drilling the orifice).

FIG. 7 provides some non-limiting examples of distal end configurations finding use in the nanosyringes as described herein. In some embodiments, the orifice plate can be formed from the same starting material as was used in the construction of the cylinder, for example, where the orifice is shaped at the same time that the cylinder is being machined from stainless steel starting material; for example, see FIGS. 7B, 7C, 7E and 7G. In other embodiments, the final structure of the nanosyringe cylinder, including the orifice plate, is added after fabrication of the cylinder, and can be made from any material, for example, sapphire, stainless steel, glass or other suitable material depending on the application. In various embodiments, the orifice plate can be formed, press fit, swaged, welded, machined, or attached by epoxy adhesive into the cylinder.

In some embodiments, the orifice plate is circular with an outer diameter the same diameter as the inner diameter of the cylinder (see for example FIG. 7A) and has a thickness of around 0.3 mm, although any other suitable thickness can be use, for example, between about 0.1 and 1.0 mm.

In some embodiments, the orifice plate is circular with an outer diameter the same diameter as the outer diameter of the cylinder (see for example FIG. 7D). This is advantageous in that it is easier to fabricate than some other embodiments as the orifice plate can be turned to an exact size after its installation.

In some embodiments, the orifice in the orifice plate is approximately 0.12-0.13 mm (120-130 microns) in diameter. In various embodiments, orifice diameters can range from about 100 microns to about 150 microns in diameter. In some embodiments, the orifice is about 125 microns in diameter.

FIGS. 7E and 7F provide advantageous embodiments of the distal geometries where the orifice channels are elongated and, as a result, will produce a laminar stream when liquid is dispensed, thereby minimizing spraying and cross contamination of adjacent wells, for example, in a multiwell chip. There are two independent features shown in these figures that provide advantages.

### (1) Longer Orifice Channel:

It was observed that the liquid being dispensed from the longer orifice channels tends to be straighter and less likely to deflect to an undesirable direction than liquid dispensed from nanosyringes having cylinder distal ends with the shorter orifice channel lengths. The velocity of the stream also is increased, giving better dispense at lower volumes.

### (2) Tapered Geometry at the End of the Nanosyringe Cylinder:

A tapered geometry discourages liquid from sticking to the bottom of the distal end of the cylinder. With flat bottom cylinders or flat bottom orifice plates, it was observed that when the cylinders or plates are retracted from a pool of liquid, there can be a significant amount of liquid stuck to the bottom of the syringe cylinder distal end or orifice plate. Also, when the dispensed liquid velocity is low, it can also result in accumulation of liquid at the bottom of the distal end of the cylinder over multiple dispense events. The tapered shape reduces the hanging drop volumes in both of these cases. A final advantage of this geometry is that the outer dimensions of the distal orifice is smaller than the diameter of the target wells and can potentially be lowered down into the well for more accurate dispensing.

In still other embodiments, other distal cylinder geometries and orifice plates also find use with the devices described herein.

FIG. 7A shows a sapphire orifice plate. In some embodiments, the sapphire orifice plates are press fit and glued, or alternatively, are swaged. In some embodiments, the sapphire plates are employed in a cylinder having a cutout in the cylinder tube to provide a step that serves as a hard stop for the jewel, and the end of the tube cylinder is swaged around the end of the jewel to hold the jewel in place.

FIG. 7B shows an orifice machined from a single piece of starting material, e.g., stainless steel.

FIG. 7C shows an orifice with an extended tapered design, which can be produced by machining.

FIG. 7D shows an orifice plate where the plate is welded onto the end of the tube.

FIG. 7E shows an orifice manufactured by machining and has the advantage of a tapered geometry.

FIG. 7F shows a tapered orifice plate insert, which can be produced, for example, using a sapphire jewel insert. This configuration has certain advantages for manufacturing, including (i) it is easier to treat the inside of the nanosyring cylinder (for example, polishing the inside surface of the nanosyringe cylinder to make it smoother), (ii) easier to keep the overall cylinder straight, and (iii) the design has a consistent dimension of the taper/orifice, and, as a result, is easier to reproducibly manufacture.

FIG. 7G shows a nanosyringe cylinder design with an orifice that finds use in contact dispensing.

FIG. 7H shows a nanosyringe cylinder design that incorporates an orifice plate with an orifice through the plate, where that design has the advantage of a longer orifice channel.

The manufacture of the nanosyringe cylinders and orifice plates having various orifice geometries and made from different materials (e.g., stainless steel or sapphire) is advantageous because the cylinder ends or orifice plates can be designed to have various desired properties. For example, distal ends or orifice plates that have a longer channel and/or in combination with a narrowed aperture channel can increase the velocity of the liquid exiting the nanosyringe. Conversely, nanosyringe cylinder distal ends having a larger aperture or a shorter exit channel can produce a slower liquid velocity exiting the nanosyringe. One of skill in the art will recognize that various manufacturing techniques can be used to custom manufacture nanosyringe cylinder distal ends or orifice plates of any desired configuration. In other embodiments, a suitable orifice size can be selected based on an optimal size to aspirate and dispense a particular cell of interest, where larger cells are optimally handled using a larger orifice size to avoid shearing damage to the cell.

### V. Contactless Dispensing and Contact Dispensing

In some embodiments, the cylinder distal end or the orifice plate geometries can be optimized for either contactless liquid dispensing or contact dispensing. The working examples described herein are configured for contactless dispensing. Namely, the dispense conditions for contactless dispensing eject fluid at a suitably high rate such that the liquid separates from the cylinder or orifice plate and travels through the air and into the receiving well. However, one of skill in the art will recognize that these devices and methods are readily adapted for contact dispensing.

Contact dispensing is achieved by slowly dispensing a fluid such that it creates a small accumulation of fluid at the bottom of the cylinder or orifice plate, then lowering the cylinder distal end until the fluid comes in contact with the dispense surface. The surface tension of the fluid will cause the fluid to stick, and when the cylinder is retracted, some or most of the fluid will remain on the dispense surface.

When contact dispensing, the cylinder or orifice plate is designed such that the ball of fluid forms in a reproducible fashion on the end of the cylinder or orifice plate. In some embodiments directed to contact printing applications, the cylinder or orifice plate is designed with a distal end that is not excessively sharp or tapered, and similarly, not too large or too flat such that it will be difficult to the drop of liquid to separate from the distal end of the cylinder or the orifice plate. In some embodiments, consistent with this present description, a cylinder and orifice consistent with this design, for example but not limited to that shown in FIG. 7G, can be used for contact dispensing.

One of skill in the art will recognize the variables and considerations in designing a cylinder end or orifice plate that is optimized for either contactless dispensing or contact dispensing. See, for example, Bammesberger et al., “A Calibration-Free, Noncontact, Disposable Liquid Dispensing Cartridge Featuring an Online Process Control,” Journal of Laboratory Automation, Vol. 19(4) 394-402 (2014); and Kong et al., “Automatic Liquid Handling for Life Science: A Critical Review of the Current State of the Art,” Journal of Laboratory Automation, 17(3) 169-185 (2012).

### VI. Dispense Volumes and Receiving Wells

The nanosyringe devices as described herein are optimally configured for dispensing nano-scale liquid volumes, e.g., between one (1) nanoliter (nL) and 999 nL. The nanosyringe devices as described herein can also be used to aspirate and dispense larger volumes.

In some embodiments, the nanosyringes as described herein are capable of reproducibly dispensing liquid volumes as small as 5 nL, 10 nL, 15 nL, 20 nL, 25 nL, 30 nL, 35 nL, 40 nL, 50 nL, 60 nL, 70 nL, 80 nL, 90 nL or 100 nL.

In some embodiments, the nanosyringes as described herein are capable of reproducibly dispensing 50 nL+/−3 nL. In some embodiments, the nanosyringes as described herein are capable of reproducibly dispensing 35 nL. In other embodiments, the nanosyringes as described herein are capable of reproducibly dispensing 20 nL.

As used herein, the expression “reproducibly dispensing” and similar expressions refer to the liquid dispensing action of a device, where the repeated programmed dispense of a given volume results in actual dispenses that differ no more than about 20%, 15%, 10%, 9%, 8%, 7%, 6%, 5%, 4%, 3%, 2% or 1% from each other.

The configuration of the receiving wells which receive the liquid dispensed from the nanosyringes is not particularly limited and will vary based on the intended use of the system. In some aspects, multi-well plates, termed chips, are used in the system. For example, a chip comprising wells having a 72×72 well configuration for a total of 5,184 wells finds particular use with the systems described herein. For example, such a chip can be a Takara Bio USA Inc., ICELL8® 5,184 well chip.

### VII. Aspiration Volumes

The actual aspiration volumes and aspiration capacities of the nanosyringe is not particularly limited and is a function of the holding capacity of the cylinder component of the nanosyringe, which is determined by the diameter of the cylinder and the usable height of the cylinder. Furthermore, these same metrics are reflected in the width and length of the plunger (in configurations where the plunger forms a tight association with the inner walls of the cylinder.

The aspiration volume is not particularly limited and is a function of the holding capacity of the cylinder component of the nanosyringe. In some embodiments, the aspiration capacity of the nanosyringe is about 12,000 nL (i.e., 12 μL). In other embodiments, the nanosyringes have larger capacities, including for example, aspiration capacities of about 15 μL, 20 μL, 25 μL, 30 μL, 40 μL or 50 μL.

In some embodiments, the aspiration volume is larger than a single dispense volume. This is beneficial for making multiple dispense events following a single larger aspiration step.

### Liquid Handling Methods and Utilities

In some aspects, the disclosure provides methods for liquid handling that find a wide variety of uses, which are immediately apparent to one of skill in the art. In one aspect, the disclosure provides methods for dispensing a liquid into a well of a multi-well device. In some aspects, that multi-well device is a multi-well plate or multi-well chip of any suitable design. In some aspects, the multi-well device comprises 5,184 fluidically isolated wells, for example, a Takara Bio USA Inc., ICELL8® 5,184 well chip. While the following discussion is provided with respect to embodiments where the actuator is a linear actuator and the elongated body is a cylinder, the invention is not so limited, e.g., as described above.

In some aspects, the methods for dispensing a liquid comprise both aspirating the liquid and dispensing the liquid. In some aspects, the methods comprise providing an apparatus comprising:
(i) a linear actuator comprising a movable shaft;
(ii) a cylinder characterized by a central channel, a proximal end and a distal end, wherein the distal end comprises an orifice;
(iii) a plunger characterized by a proximal end and a distal end, wherein:
   (A) the proximal end is mechanically coupled to the movable shaft, and
   (B) at least a portion of the distal end of the plunger is moveably positioned within the central channel of the cylinder.

As part of this system, also included is any suitable receiving vessel, tube, dish, plate, multi-well dish or chip, or the like, without reservation. In some aspects where a multi-well device is used, the multiple wells are fluidically isolated. The multi-well device is capable of being positioned in a location to receive liquid dispensed from the nanosyringes. In some aspects, the multi-well device is on a movable stage that can change position in the x/y plane to position any given well or grouping (e.g., subset) of wells underneath a nanosyringe or nanosyringe array.

A first step in the method is to position the distal end of the cylinder into a source plate well containing the liquid to be dispensed. Liquid is aspirated into the syringe by retracting the linear actuator shaft, thereby retracting the plunger in the cylinder channel, and thereby aspirating the liquid into the cylinder channel. The nanosyringe is then withdrawn from the source plate well and the distal end of the cylinder is repositioned above a well of the multi-well device receiving vessel. Dispending is accomplished by extending the linear actuator shaft, thereby extending the plunger in the cylinder channel, and thereby forcing the liquid from the cylinder channel into the well of the multi-well device.

In some aspects, the multi-well device or any other receiving vessel is associated with a heating element capable of heating and/or cooling and maintaining the multi-well device at a suitable temperature. In some embodiments, the heating device is capable of maintaining at least two different temperatures which can selected by the user. In some embodiments, the heating element has the capacity to heat the multi-well device as a temperature cycler and function as a thermal cycling device as used in a polymerase chain reaction.

The volumes of liquids that are dispensed by these methods is not particularly limited. For example, in some embodiments, liquid is dispensed in a volume between about 10 nanoliters (nL) and 300 nL. In one aspect, the volume that is dispensed is a reproducible volume, that is to say, the volume is the same or nearly the same within some acceptable margin of variability between multiple dispense events. In some aspects, the volume of liquid aspirated is the same as the volume of liquid dispensed.

In other aspects, the volume of the liquid aspirated is larger than the volume of liquid dispensed. This is advantageous because multiple dispense events can be made following a single aspiration event.

The nature of the liquid that is aspirated and dispensed is not particularly limited. One of skill will recognize a myriad of liquids and useful applications of the liquid handler devices and apparatus as described herein.

In some embodiments, the liquid is a liquid reagent or reagent mix. The components of a reagent solution or reagent mix will frequently modify or react with the components of a sample prior to some type of analysis. The nature and constitution of a reagent solution varies widely depending on the intended use.

In some aspects, the reagent fluid is a biochemical reaction mixture. For example, in some embodiments, the reagent fluid is a reaction mixture such as a polymerase chain reaction master mix that can comprise any type of suitable enzymes, probes, primers, or other reagents as might be included in such a reaction In some embodiments, the reaction mixture comprises one or more of, but not limited to, a buffer, an enzyme, dNTPs, a primer, a template switch oligonucleotide, or any combination thereof. In some embodiments, a reagent mix can also include a mock sample, e.g., a nucleic acid template that can act as a positive control for the components of the reagent mix. The reaction mixture can be a Next Generation Sequencing (NGS) library preparation reaction mixture, and further, the methods as described herein can comprise performing an NGS reaction. The scope of useful reagent mixes for biochemical reactions is broad and without limitation, including for example, PCR reagent mixes, RT reagent mixes, reagent mixes for any type of nucleic acid sequencing, including but not limited to Next Generation Sequencing or single molecule sequencing, reagent mixes for any type of cloning.

In other aspects, the liquid being manipulated by the liquid handling devices as described herein are liquid samples.

In various embodiments, samples and reagents are at some point combined, i.e., mixed. In some embodiments, this combining step occurs in the wells of a multi-well device. In some embodiments, the fluid handling devices described herein, e.g., the nanosyringe, delivers both the sample and the reagent fluid to the wells of the multi-well device in two separate handling steps. In some embodiments, either the sample or the reagent mix is predistributed in the wells of a chip prior to the addition of the other, so that the fluid handling device of the disclose will only distribute either the sample or the reagent mix to the wells of the multi-well device.

In some embodiments where the liquid handling device is delivering both the sample and the reagent mix to the wells of a multi-well chip, the order of the addition is not limited, as the sample or reagents can be added in any sequence.

In some embodiments, the apparatus and systems described herein can comprise a camera and associated components, such as light sources, lenses and filters, for imaging the contents of the individual wells of a multi-well device such as a multi-well plate or chip. These cameras are useful for a variety of purposes, including in some embodiments for verification of proper delivery of sample or reagent fluid to the individual wells. In some embodiments, the camera is able to image, quantitate or real-time monitor the accumulation of a product generated by a biochemical reaction, e.g., an amplicon generated by a PCR reaction. In some aspects, the biochemical reaction is a PCR reaction and the camera imaging is a quantitative imaging measuring the accumulation of PCR product amplicon produced by the reaction. In other embodiments, a camera as described herein can also be used to align the multi-well chip, to read barcodes or other identifying information that might be on the multi-well chip or source plate, or to image and identify, e.g., count, cells within the wells of a multi-well chip.

### Computer Controlled Systems

Aspects of the present disclosure further include systems, such as computer-controlled systems, for practicing embodiments of the above methods. In some instances, the systems further include one or more computers for complete automation or partial automation of the methods described herein. In some embodiments, systems include a computer having a computer readable storage medium with a computer program stored thereon.

In some embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, a barcode reader, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, Python, Java Script, C#, Go, R, Swift, PHP, or other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system. In some embodiments, processors include analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

The processor may include a general-purpose digital microprocessor suitably programmed from a computer readable medium carrying necessary program code. Programming can be provided remotely to the processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In some embodiments, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In some embodiments, the communication interface is configured for infrared communication, Bluetooth® communication, or any other suitable wireless communication protocol to enable the subject systems to communicate with other devices such as computer terminals and/or networks, communication enabled mobile telephones, personal digital assistants, barcode readers, or any other communication devices which the user may use in conjunction.

In some embodiments, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via a system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, CSV files, email or other files, or data in other forms. The data may include Internet URL addresses so that a user may retrieve additional SQL, HTML, XML, CSV, or other documents or data from remote sources. The one or more platforms present in the subject systems may be any type of known computer platform or a type to be developed in the future such as servers. However, they may also be a main-frame computer, a workstation, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows, iOS, Oracle Solaris, Linux, IBM i, Unix, and others.

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming”, where the term “computer readable medium” as used herein refers to any non-transitory storage medium that participates in providing instructions and data to a computer for execution and processing. Examples of suitable non-transitory storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer.

The non-transitory computer readable storage medium may be employed on one or more computer systems having a display and operator input device. Operator input devices may, for example, be a keyboard, mouse, barcode reader, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available.

### EXAMPLES

The structures, materials, compositions, and methods described herein are intended to be representative examples of the disclosure, and it will be understood that the scope of the disclosure is not limited by the scope of the examples. Those skilled in the art will recognize that the disclosure may be practiced with variations on the disclosed structures, materials, compositions and methods, and such variations are regarded as within the ambit of the disclosure.

### Example 1

### Nanoliter Dispensing Over a Range of Volumes

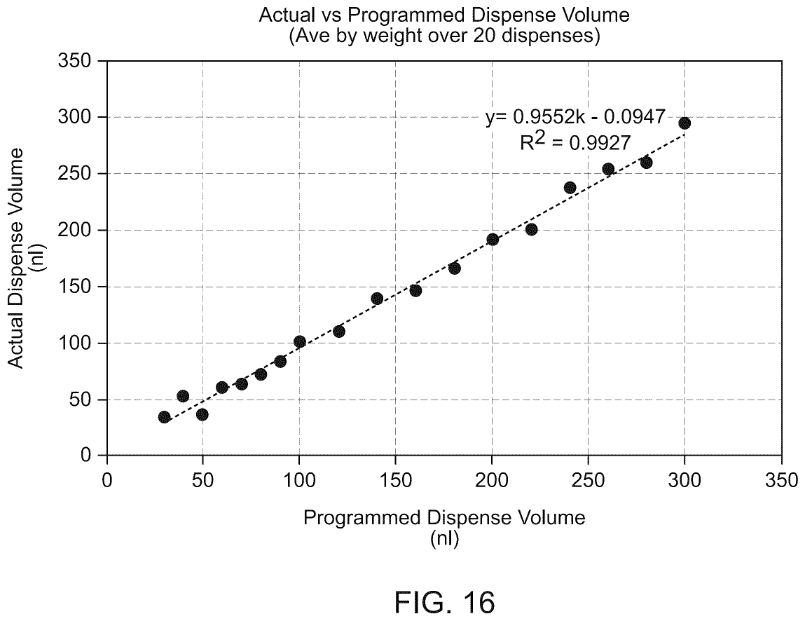

A study was conducted to observe the dispense accuracy of the nanosyringe of the present disclosure and was tested over the range of 30 nL to 300 nL using water as the dispense medium. These results are shown in FIG. 16.

A nanosyringe comprising a stepper motor linear actuator coupled to a plunger residing in a channel of a stainless-steel cylinder was used in the experiment, consistent with the present description. This configuration used a cylinder having a sapphire orifice plate with a design similar to that shown in FIG. 7A. The sapphire orifice plate incorporated an orifice of approximately 125 micron diameter. The plunger had a diameter of approximately 32 mils and the diameter of the cylinder channel was approximately 33 mils. The plunger speed was programmed to 66.5 mm/sec for this test.

The nanosyringe was programmed to dispense water in 10 nL increments from 30 nL to 100 nL and in 20 nL increments from 120 nL to 300 nL. The actual volume dispensed was determined by weight using a microbalance. Twenty dispenses were done onto a glass slide at each dispense increment and the results averaged. A cover slide was used to prevent evaporation during measurement. The actual dispense volume versus the programmed volume is shown in FIG. 16. As can be seen in FIG. 16, the correlation between the programmed and actual dispense volume is extremely good over the range of interest.

### Example 2

### Reproducibility of Liquid Dispensing of 35 nL and 100 nL from a Nanosyringe

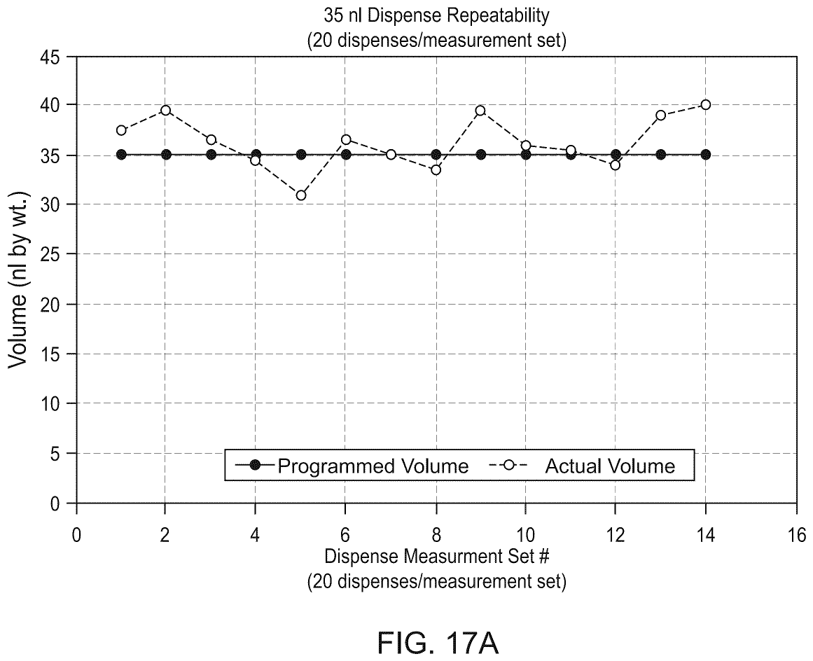

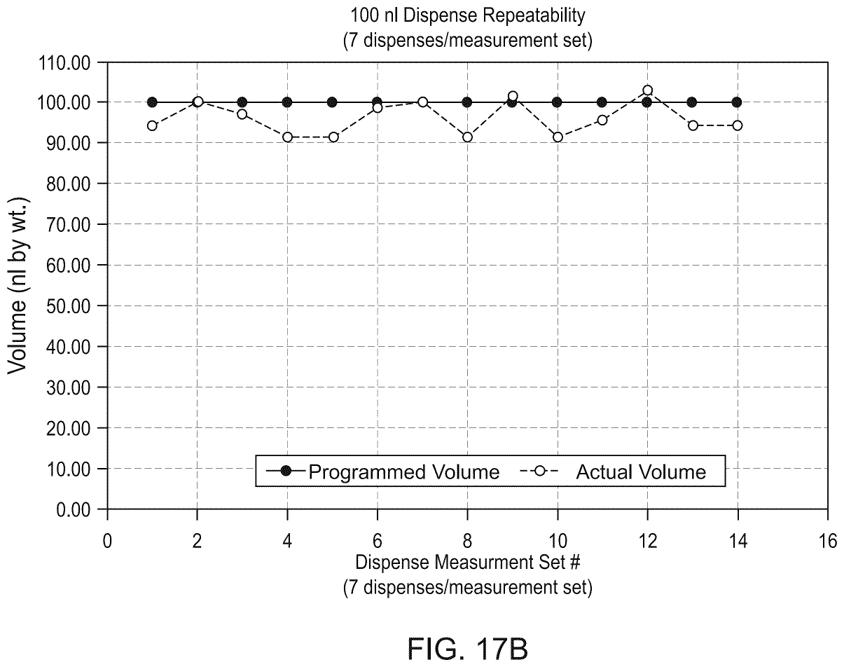

A study was conducted to verify the reproducibility of dispensing 35 nL and 100 nL test volumes from a nanosyringe as described in the present disclosure. These results are shown in FIGS. 17A and 17B.

A nanosyringe comprising a stepper motor linear actuator coupled to a plunger residing in a stainless-steel cylinder channel was used in the experiment, consistent with the present description. This configuration used a cylinder having an orifice plate that was welded and then drilled with a configuration similar to that in FIG. 0.7A. The orifice plate incorporated an orifice of approximately 125 micron diameter. The plunger had a diameter of approximately 32 mils and the diameter of the cylinder channel diameter was approximately 33 mils. The plunger speed was programmed to 66.5 mm/sec for these tests.

Multiple dispenses were made at each tested dispense volume, where the programmed 35 nL dispense was repeated 20 times and the programmed 100 nL dispense was repeated 7 times. The actual dispense volume was estimated by taking a total cumulative weight of the dispense events, where the repeated dispense events were required in order to bring the total dispensed weight within the range of the microbalance. The multiple dispenses were immediately covered after dispensing to prevent evaporation and weighed immediately. The cumulative weight of the dispensed fluid was converted into a volume estimate based on the fluid density and the number of dispenses, and then plotted against the programmed dispense volume. These results are shown in FIGS. 17A and 17B. The two graphs show good correlation between programmed dispense volume and actual dispense volume, for both the 35 nL volume testing and the 100 nL volume testing.

### Example 3

### Reproducibility of Liquid Dispensing of Volumes Ranging from 20 nL to 50 nL from a Nanosyringe

A study was conducted to examine the reproducibility of liquid dispensing from a nanosyringe, as described in the present disclosure, over volumes ranging from 20 nL to 50 nL. This experiment was conducted by measuring the volumes of liquid dispensed from the nanosyringe device using an ImageXpert Inc.® JetXpert Jr™ (formerly known as JetXpert OEM) inline droplet visualization and measurement platform.

The nanosyringes were configured as per the teaching of the present disclosure. A Nanosyringe comprising a stainless-steel cylinder with an internal channel diameter of 0.86 mm was used, where the distal end of the cylinder was fitted with an orifice plate having a circular orifice with a diameter of 125 microns therethrough. The orifice plate used a configuration similar to that shown in FIG. 7A. Within the cylinder resided a stainless steel plunger having a diameter of 0.84 mm. A seal was mated between the proximal end of the cylinder with the plunger shaft residing within the cylinder channel. The seal was made of a poly ether ether ketone (PEEK) composite plastic.

The maximal stroke length of the plunger was 24 mm, which resulted in a total nanosyringe capacity of approximately 12 μL. Aspiration with the nanosyringe was accomplished by retracting the plunger away from the distal end of the cylinder and dispensing was accomplished by extending the plunger towards the distal end of the cylinder.

The dispense was made in a programmed three phase cycle, which included an initial start velocity, followed by two acceleration phases (the fastest of which was 4,768 mm/sec²), until reaching the maximum velocity of 66.5 mm/second. The motor current setting was 700 mA and a motor microstep mode of 6400 microsteps per revolution.

Data acquisition during the programmed dispensing of water was performed with ImageXpert Inc.® JetXpert Jr™ (formerly known as JetXpert OEM) inline droplet visualization and measurement platform. The JetXpert Jr's camera was synchronized with the nanosyringe controller so that images of the dispensed fluid stream could be captured in its entirety. The JetXpert Jr's software is capable of performing image processing on the captured image to estimate the total volume of the fluid.

The nanosyringe assembly was positioned such that the distal end of a single nanosyringe channel's cylinder was just above the JetXpert Jr's field of view. The nanosyringe was filled manually by submerging the distal end of the cylinder in a disposable tube with deionized water, then aspirating 12 μL of water. The nanosyringe was programmed to make 200 dispenses of the target volume 50 nL with a pre-dispense delay of 50 ms and a post-dispense delay of 50 ms. The JetXpert captured one in every 4 images, and the resulting data was recorded. This experiment was repeated for the dispense volumes of 45 nL, 40 nL, 35 nL, 30 nL, 25 nL, and 20 nL. A total of 50 images were acquired for each dispense volume.

The results are depicted in the table below.

| Dispense volume (nL) | 50 | 45 | 40 | 35 | 30 | 25 | 20 |
|---|---|---|---|---|---|---|---|
| Average (nL) | 51.27 | 46.07 | 39.74 | 32.91 | 31.12 | 26.06 | 20.67 |
| STDV | 4.68 | 1.38 | 2.11 | 4.56 | 3.18 | 2.80 | 1.58 |
| CV (%) | 9% | 3% | 5% | 14% | 10% | 11% | 8% |

CV, or coefficient of variation, is the ratio of the standard deviation to the mean (STDV/Average)

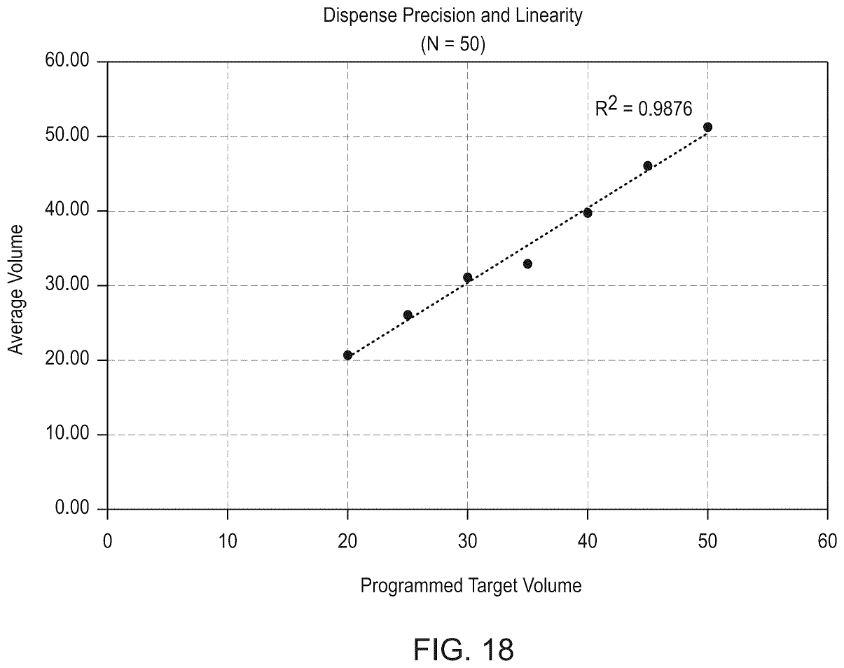

These results are depicted graphically in FIG. 18. As can be seen in the table above and in FIG. 18, there is good linearity between the programmed target volumes and the measured volumes (slope of 1.0034), the dispense CVs were less than 15%, and dispense resolution of 5 nl. The minimum dispense volume of 20 nl was also demonstrated.

### Example 4

### Accuracy of Liquid Dispensing onto a Nanowell Array

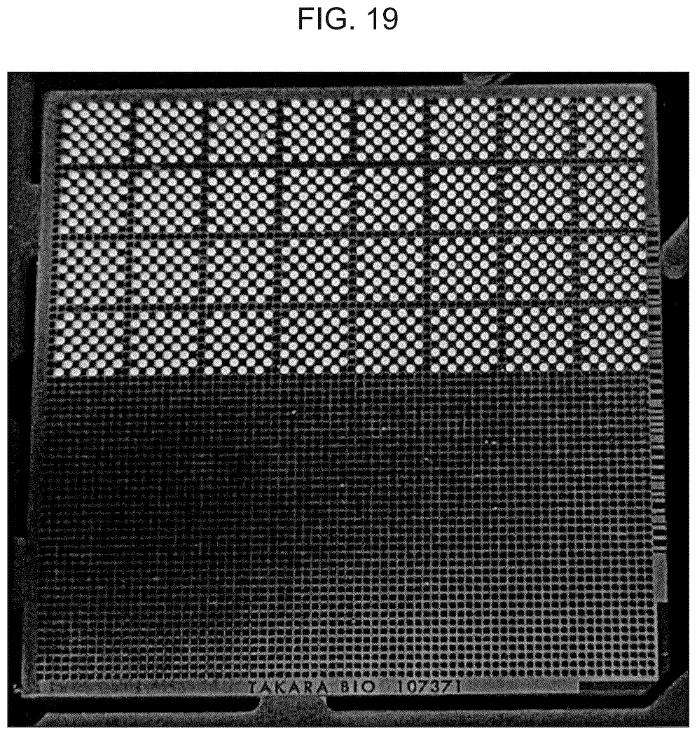

A study was conducted to verify the integrity of liquid dispensing from a nanosyringe as described in the present disclosure. These results are shown in FIG. 19.

An experiment was designed to demonstrate the accuracy of the nanosyringe to accurately dispense liquid volumes into the nanowells of a Takara Bio USA Inc., ICELL8® 5,184 well chip. The chip was installed on the chip platform of a liquid dispensing apparatus that incorporates the nanosyringes of the present disclosure.

The apparatus, which consisted of a 2×4 array of nanosyringes, was programmed, in separate experiments, to deliver 35 nL or 50 nL of a liquid volume from a 384-well source plate to predetermined well addresses on a multiwell chip. The nanosyringes were configured and used dispense parameters as per the teaching of the present disclosure and as described in EXAMPLE 3.

The liquid dispensed contained a UV dye. The liquid was delivered to predetermined wells in a regular repeating checkerboard pattern across four aspiration-dispense-wash cycles. For the dispense portion of each cycle, the 2×4 array of nanosyringes simultaneously deposited the liquid in 32 wells in a checkerboard pattern, such that each well that contained the liquid was surrounded by 3 to 4 empty wells. This allows for inspection of the empty wells for visual indication of cross contamination. Following liquid delivery, the chip was removed from the apparatus and imaged on a Takara Bio USA SmartChip® Real-Time PCR system.

An image from a representative experiment dispending 35 nL is shown in FIG. 19. Similar results were obtained for a dispense volume of 50 nL. This image demonstrates the accurate dispensing of liquid volumes to programmed addressable locations on the 5,184 well chip, no cross contamination (i.e., no dispensing and no contamination of non-programmed well locations), and based on dye intensity, approximately uniform dispense volumes delivered to each programmed well. This image demonstrates accurate programmed dispensing from the nanosyringe using test volumes of 35 nL or 50 nL.

### Example 5

### Assessment of Contamination in Liquid Dispensing from a Nanosyringe

A study was conducted to verify the reproducibility and integrity of dispensing properties of a nanosyringe as described in the present disclosure. Positive and negative control reagent mixes for a PCR amplification reaction were dispensed to the wells of an a ICELL8® 5,184 nanowell chip (Takara Bio USA, San Jose, CA), and the amplification products were quantitated through a qPCR reaction. This testing assessed the degree of cross contamination and carryover contamination in the nanosyringe dispensing system.

As used herein, the expression “cross contamination” refers to contamination that is happening external to the nanosyringe cylinder as a result of an improper dispensing event, for example, where a satellite droplet from the nanosyringe cylinder distal end may land in a neighboring well. Another illustration of cross contamination refers to a scenario where there is gross failure of the liquid to make a bridge between the cylinder distal end and well of a chip, and as a result, the liquid dispensed from the nanosyringe cylinder distal end is dragged across multiple wells.

As used herein, the term “carryover contamination” refers to contamination that occurs within the nanosyringe cylinder, for example, if the cylinder wash step was insufficient, and as a result, some of the previous liquid mixes with the newly aspirated liquid.

Nanosyringes were tested using an interdigitated pattern of positive and negative control reagent solutions dispensed on a 5,184 nanowell plate to check for carry over and cross contamination.

The nanosyringes were configured as per the teaching of the present disclosure. A stainless-steel cylinder with an internal channel diameter of 0.86 mm was used in each syringe, where the distal end of the cylinder was fitted with an orifice plate having a circular orifice with a diameter of 125 microns therethrough. The orifice plate used a configuration similar to that shown in FIG. 7A. Within the cylinder resided a stainless steel plunger having a diameter of 0.84 mm. The maximal stroke length of the plunger was 24 mm, which resulted in a total nanosyringe capacity of approximately 12 μL. A seal was used to mate the proximal end of the cylinder with the plunger shaft residing within the cylinder channel. The seal was made of Delrin® plastic.

A test solution containing qPCR reagents, comprising a positive control template that is expected to generate an amplicon, was dispensed to preprogrammed locations on the 5,184 well chip. This testing was done to assess the washing efficacy when switching between solutions containing qPCR reagents comprising the positive control template and wash solutions to test how effectively the nanosyringes can be cleaned between qPCR reagent dispensing steps.

The first part of the experiment was to look at levels of cross contamination while dispensing into a nanowell chip. A qPCR positive reagent mix and PCR negative control reagent mix lacking a template nucleic acid were prepared and loaded into wells at opposite ends of a 384-well source plate, and the two ends of the plate were individually sealed. The source plate and an empty 5,184 well chip were placed in the chamber of the liquid handler system of the current disclosure. The source plate was oriented such that the negative qPCR reagent mix could be dispensed. The predetermined “negative checkerboard” dispense pattern was initiated through the controlling software and the nanosyringes were used to deliver 35 nL of negative qPCR reagent mix. This was accomplished over 10 aspiration-dispense-wash cycles. Each wash cycle consisted of a sequence of maximal stroke length aspirations at a programmed Vmax of 10 mm/sec and A1 acceleration of 40 mm/sec² from fluid supplied from the bleach or water trough followed by purging the contents into the waste trough at a programmed Vmax of 300 mm/sec and A1 of 5,000 mm/sec².

The negative checkerboard pattern fills one half of the chip entirely with negative control qPCR mix (termed NTC, or no template control), and the other side is filled only in a checkerboard fashion. After the dispense was complete, the chip was blotted to remove any liquid on the top of the chip, and the orientation of the source plate was reversed so that the positive qPCR reagent mix could be dispensed. The predetermined “positive checkerboard” pattern was initiated through the software and the nanosyringes were used to deliver 35 nL of positive qPCR reagent mix only to the checkerboard side of the chip, in the alternating wells to the negative qPCR mix. This was accomplished over 8 aspiration-dispense-wash cycles. Having the positive wells surrounded by negative wells is a way to assess the level of cross contamination, namely that if a significant amount of the positive reagent mix were to fall into a neighboring negative control wells, there would be amplification event observed in the negative control wells.

After the positive qPCR reagent dispense was complete, the chip was again blotted to remove any liquid on the top of the chip. The chip was removed, sealed, centrifuged, then subjected to thermal cycling and imaging on the SmartChip cycler (Takara Bio USA, Inc. San Jose California).

A second, complementary experiment was also conducted to look at carryover contamination. The same qPCR positive control and negative control reagent mixes were prepared and the experiment described above was repeated, except that the positive wells were dispensed before the negative wells.

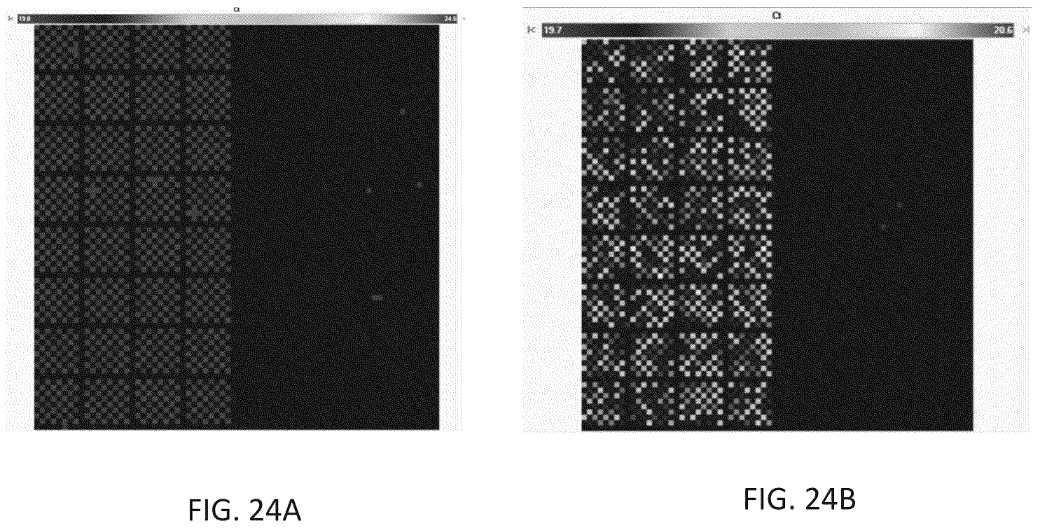

For the experiment looking at cross contamination, FIG. 24A provides a photograph of the nanowell chip imaged following amplification. Wells where amplification has occurred appear lighter in color than negative wells, which appear black in the image. The right side of FIG. 24A contains negative control reagent mix dispensed to each well. This right side was used the calculate the natural background level of contamination. The positive and negative checkerboard wells are shown on the left side of FIG. 24A. The data collected from FIG. 24A is summarized in the table below. The % delta true contamination is the contamination % from the left side minus the % natural background contamination from the right. The black wells in the figure are wells that have a Cₜ value>6 from the average Ct value of the true positive wells from the checkerboard pattern on the left side. These wells are not counted.

| Metric | Passing Criteria | Result | Pass/Fail |
|---|---|---|---|
| Lot Expected Cₜ | 19.5 | N/A | N/A |
| Average Cₜ | Lot Expected | 20.9 | Pass |
| | Cₜ +/− 1.55 | | |
| Cₜ SD (standard deviation) | ≤0.290 | 0.11 | Pass |
| % Natural Background | ≤0.25% | 0% | Pass |
| Contamination | | | |
| % Delta True Contamination | ≤0.28% | 0% | Pass |

The lot expected Ct (or threshold cycle) metric is used to confirm that there was no gross error with the thermocycling or qPCR positive control reagent mix preparation. The Ct SD gives an indication for the uniformity of the dispense and inherently the uniformity of the environmental conditions experienced by the nanowells. The % natural background is the number of wells from the right side of the chip that had a Ct within 6 Cts of the average true positive well divided by the total number of wells on this side (i.e., 2,592 wells). This percentage is used as the cutoff for what is defined as a “significant” level of contamination. This number is used as the baseline for the contamination level of the nanowell chip. The % delta true contamination represents the percentage of wells expected to be negative on the left side of the nanowell chip that had a Ct that is within 6 Cts of the average true positive well Ct value minus the % natural background contamination. As shown in the table above, all metrics passed the preset criteria for successful dispensing with only minor, i.e., experimentally acceptable, levels of cross contamination.

The results for the complementary carryover contamination experiment are shown in FIG. 24B, and represented in the table below:

| Metric | Passing Criteria | Result | Pass/Fail |
|---|---|---|---|
| Lot Expected Cₜ | 19.5 | N/A | N/A |
| Average Cₜ | Lot Expected | 19.95 | Pass |
| | Cₜ +/− 1.55 | | |
| Cₜ SD (standard deviation) | ≤0.290 | 0.14 | Pass |
| % Natural Background | ≤0.25% | 0% | Pass |
| % Delta True Contamination | ≤0.28% | 0.13% | Pass |

As shown in the table above, all metrics passed the preset criteria for successful dispensing with only minor, i.e., experimentally acceptable, levels of, carryover contamination. Thus, the nanosyringe cylinder washing protocol with a 0.2% bleach solution was effective in cleaning the inside of the cylinders to remove or at least denature or inactivate any carryover contamination material

Collectively in view of the results of the experiments depicted in FIGS. 24A and 24B, there was found to be no cross contamination or carryover contamination of significant levels (i.e., no amplification in the negative control wells that were within 6 Ct of the average Ct value of the true positive wells.

### Example 6

### Dispensing from a Nanosyringe to a Nanowell Chip in a Temperature and Humidity Controlled Environment

A study was conducted to measure the effect of dew point control on the reproducibility of liquid dispensing of a nanosyringe to the wells of a ICELL8® 5,184 nanowell chip (Takara Bio USA, San Jose, CA). To measure the effect of dew point control on the accuracy of dispensing properties of a nanosyringe to the wells of a 5,184 nanowell chip, reagents, including a positive control template, for a PCR amplification reaction were dispensed into two identical chips. One chip was processed in the absence of a dew point controlled environment (i.e., without temperature control and without humidity control), and the second chip was processed in an environment with dew point control (i.e., with temperature and humidity control).

The nanosyringe device configuration used to distribute the qPCR reagents, including the positive control template, to the chip nanowells comprised a pair of nanosyringes wherein each nanosyringe had a cylinder inner diameter of 33 mils and a plunger diameter of 32 mils. The distal end of each cylinder of the device was similar to the design shown in FIG. 7D. The syringes were programmed to dispense with a plunger Vₘₐₓ of 66.5 mm/sec. The seal material was Teflon™.

The qPCR reagent mix, including positive control template, was dispensed from two nanosyringes, in 8×72 well blocks, starting on one side of the chip and systematically progressing across the entire chip. After the dispense, the cylinders were washed and the process was repeated for a total of four cycles to fill the chip. The two chips were subjected to amplification temperature cycling, and amplification products were quantitated.

It was observed that on the chip without temperature control during the dispensing, the first three dispense cycles had significant failures of the qPCR chemistry, whereas the last two sectors that received qPCR reagents on that same chip had much better performance. This indicates that the reactions in the wells of the first three dispense sectors were negatively impacted by evaporation, but the last two were not as severely impacted.

The chip that was processed with temperature and humidity control during the dispensing step showed significant improvement in the percentage of wells with successful qPCR reactions, with uniform successful amplification reactions across all sectors of the chip. The improved results were the result of dew point control.

Thus, both the chip temperature and the dispense chamber humidity were controlled to achieve dew point. The dew point controller set the temperature of the chip by regulating the temperature of the mounting chuck beneath the chip. In this example, the temperature of the chip was regulated to bring the system to the dew point target because the chip was maintained at a temperature between evaporation and condensation. The dispensing chamber was an enclosed environment, and there was a humidifier module as part of the apparatus; temperature control was successfully achieved by controlling the temperature under the chip. The apparatus included a humidity/temperature sensor that monitors the environmental conditions inside the dispense chamber and calculates the desired dewpoint temperature to control the chip. This temperature and humidity regulation optimizes chemistry performance, presumably by minimizing evaporation loss and condensation.

### Example 7

### Assessment of Cell Viability Following Dispensing Cells from a Nanosyringe to a Nanowell Chip

Objective: A study was conducted to measure cell viability following aspiration and dispensing of mammalian cells from the nanosyringe to the wells of a 384 well plate.

### Materials and Methods:

Human lymphocyte K562 cells were counted with the ORFLO® Moxi Flow (ORFLO Technologies, Ketchum, ID), diluted to 50,000 cells/mL, and counted again to confirm the starting concentration. From this solution, three samples were created for testing.

### (i) Control Sample.

The control sample was loaded into the 384-well source plate and was subject to the same environmental conditions as the two dispense systems of (ii) and (iii), but was not dispensed.

### (ii) Samples Dispensed Using Nanosyringes.

Samples were dispensed with eight nanosyringes as described in the disclosure, using a cylinder distal end style similar to that shown in FIG. 7A. Cells were aspirated from a 2×4 grid of wells on a 384-well source plate and dispensed into a pool in fresh wells on the same source plate. The dispense used pulses that mimic the dispensing of liquid volumes into individual nanowells on an ICELL8 chip.

(iii) Samples Dispensed with a Takara Bio ICELL8 cx System.

Samples were dispensed using a Takara Bio ICELL8 cx system. Cells were aspirated from a 2×4 grid of wells on a 384-well source plate and dispensed into a pool in fresh wells on the same source plate. The dispense used pulses that mimic the dispensing of liquid volumes into individual nanowells on an ICELL8 chip.

Approximately 5,000 dispenses were performed using methods (ii) and (iii). The dispenses from the 8 nanosyringes were pooled for each system and, along with the controls for each system, were stained with propidium iodide. The cell viabilities were measured as a percentage of the total cells in the sample for each of the three samples using the Moxi Flow. The Moxi Flow counts the cells using the Coulter effect, but as each cell passes through the orifice used for counting in the flow cell, it also triggers the optics to take a fluorescence measurement to excite PI and check for the dead stain signal.

This experiment was repeated 3 times with the nanosyringe system, and 3 times with the Takara Bio ICELL8 cx system. Cell viabilities were measured on an ORFLO® Moxi Flow cassette-based flow cytometer.

### Results/Data:

The following cell viability measurements were obtained.

| | % cell |
|---|---|
| Sample (N = 3) | viability |
| (i) Control (no aspiration or dispensing) | 95.1% ± 2.7% |
| (ii) Nanosyringe with distal end similar | 93.9% ± 3.2% |
| to that shown in FIG. 7A | |
| Delta Viability (Avg) | 1.2% |

| | % cell |
|---|---|
| Sample (N = 3) | viability |
| (i) Control (no aspiration or dispensing) | 94.5% ± 0.9% |
| (iii) Takara Bio ICELL8 cx | 92.6% ± 2.4% |
| Delta Viability (Avg) | 1.9% |

The cell viability measurements were similar across the control and experimental systems.

There was no obvious damage to the cells from the nanosyringe based on the Moxi Flow plots data, which showed no shift in the plot distribution following nanosyringe dispensing. The cluster locations on the dispensed vs control populations look relatively the same in all 3 runs. Dispensing with the nanosyringe tip style shown in FIG. 7A did not have a significant impact on the cell viability of Human lymphocyte K562 cells.

### Example 8

### Successful Use of SSPro in a 5,184 Well Chip Using Nanosyringe Liquid Handling

A study was conducted to demonstrate the effectiveness of nanosyringes as described herein to enable single-cell full length transcriptome analysis using the Takara Bio USA, Inc. SMART-Seq® Pro application protocol for transcriptome analysis of single cells. The analysis was conducted on a Takara Bio USA Inc., ICELL8® 5,184 well chip. Human peripheral blood mononuclear cells (PBMCs) were used in the analysis.

The SMART-Seq® Pro Application Kit (Takara Bio USA, San Jose, CA) carries out full-length transcriptome library preparation workflow on the ICELL8® cx Single-Cell System (Takara Bio USA, San Jose, CA), which enables the automated preparation of full-length single-cell mRNA libraries of greater than 1,000 single-cells in the processing of a single sample. This tool has many valuable applications, including study of alternative splicing, biomarker discovery such as cancer biomarker discovery, and discovery of rare biological events (e.g., gene fusions, isoforms). Together with Cogent™ NGS bioinformatics tools, SMART-Seq® Pro creates an end-to-end, automated solution for biomarker discovery, offering an efficient way to accelerate translational research by providing insight into important biomarkers in single-cell samples.

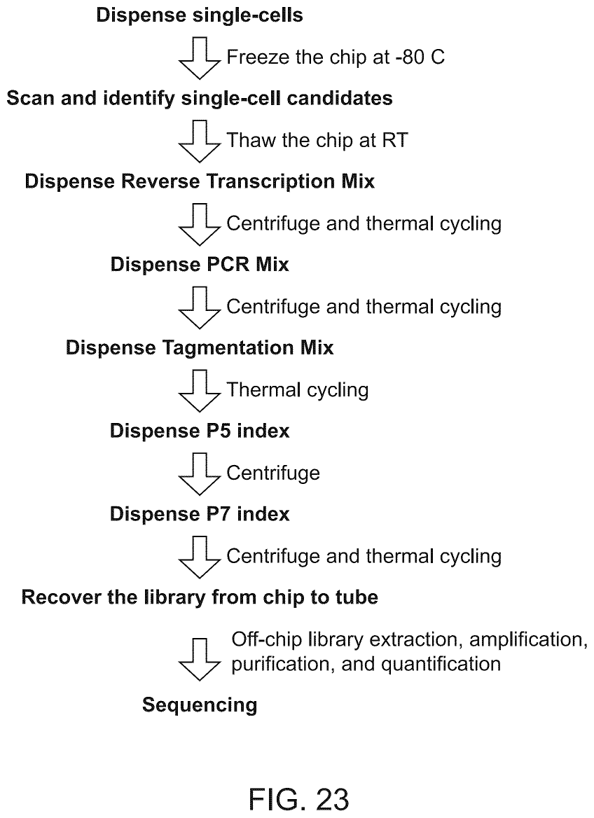

The SMART-Seq® Pro Application Kit workflow is illustrated in FIG. 23. First, single cells were dispensed into each individual wells of the 5,184 well chip. Wells with live single-cell candidates were identified via fluorescence imaging and selected for downstream reagent dispense. The chip went through one freeze-and-thaw cycle at −80° C. to lyse the cells before reagent dispense. There were total of 5 reagent dispense steps to complete the SMART-Seq® Pro protocol (reverse transcription, PCR cDNA amplification, tagmentation, i5 index and i7 index), with chip centrifuge and thermal cycling between each dispense step to produce the corresponding products. After the cDNA library was synthesized and barcoded with i5 and i7 indexes, the resulting NGS library was recovered from the chip into a 1.5 mL Eppendorf tube for the off-chip extraction, amplification, purification, and quantification processes before loading the library to the sequencer (Illumina NextSeq500, Illumina Inc, San Diego CA).

This experiment was performed in parallel using two different liquid handling systems. In one experiment, the dispense of cells and reagents was conducted on a Takara Bio USA ICELL8® cx Single-Cell System for single cell manipulation. In another experiment, the dispense of cells and reagents was conducted using a liquid handling system incorporating the nanosyringe device as described herein. The two experiments used identical samples, reagents and workflow.

The experiment done using the Takara Bio USA ICELL8® cx Single-Cell System followed the manufacturer's recommended protocols for both the Takara Bio USA ICELL8® cx Single-Cell System and for the Takara Bio USA, Inc. SMART-Seq® Pro application protocol for transcriptome analysis of single cells.

The experiment using a liquid handling system with a design of the current disclosure incorporating an array of nanosyringe devices is described in detail below. This design for the liquid handling system was fitted with a 2×4 array of individually controllable nanosyringes for depositing samples and reagents. The nanosyringe assembly was mounted on a linear Z stage and was enclosed in a environmentally controllable chamber. The chamber had a sensor for monitoring the chamber's internal temperature and humidity, and a humidifier module for increasing the chamber's humidity. The chamber's working platform, which sat on a moveable XY stage, had a dedicated location for a 384-well source plate and a temperature-controlled location for a 5,184-well nanowell chip, namely, the Takara Bio USA Inc., ICELL8® 5,184 well chip.

While the system is actively dispensing, the dewpoint control subsystem monitors the chamber's temperature and humidity and controls the chamber's humidity and nanowell chip's temperature such that nanowell chip is maintained at the dew point, the point between evaporation and condensation. The dewpoint control capability of the liquid handling system is crucial for ensuring there is no significant evaporation or condensation for the duration of the dispense, which in the case of the SMART-Seq Pro protocol can vary between 10 and 30 minutes per sample or reagent dispense step. Also contained on the working platform is a 3-well wash station, which consists of a bleach trough, a water trough, and a waste trough, and is used for cleaning the interior and exterior of the nanoysyringe cylinders and orifice at the end of each aspiration-dispense cycle.

The nanosyringe cylinders were configured with a geometery similar to that shown in FIG. 7A, comprising a stainless steel cylinder with an internal channel diameter of 0.86 mm, and where the distal end of the cylinder is fitted with an orifice plate having a circular orifice with a diameter of 125 microns therethrough. Within the cylinder resided a stainless steel plunger having a diameter of 0.84 mm. The seal which mates the proximal end of the cylinder with the plunger shaft residing within the cylinder channel was made of Delrin® plastic. The maximal stroke length of the plunger was 24 mm, which resulted in a total nanosyringe capacity of approximately 12 μL. Generally speaking, aspiration with the nanosyringe was accomplished by retracting plunger away from the distal end of the cylinder and dispense was accomplished by extending the plunger down towards the distal end of the cylinder.

The stepper motors that drive the nanosyringes and the XYZ stages of the liquid handler are driven by a TRINAMIC Motion Control TMCM-6212 motion controller board (Hamburg, Germany), which supports the TRINAMIC SixPoint™ ramp generator. The six point ramp features two different acceleration settings for the acceleration phase and two different deceleration settings for the deceleration phase, with the option of using non-zero starting and stopping velocities. See FIG. 22. The cycle begins with start speed Vstart, then uses acceleration value A1 to accelerate until the motor reaches V1. Then the motor is further accelerated using acceleration value A2 until it has reached the speed Vmax. Similarly for the deceleration phase, the motor begins decelerating using deceleration value D2, and after the motor reaches speed V1, the motor is decelerated with value D1 until the motor teaches the stop speed Vstop.

The linear stepper motors used for the nanosyringe was obtained from DINGS' MOTION USA™ (Morgan Hill, CA), and had 200 steps per revolution. For this experiment, the motors were run at a microstepping mode of 32, in other words a total of 6400 microsteps per revolution. The max current used with the motors during motion was 900 mA with a holding current of 100 mA.

The first step in the protocol was for the nanosyringes to dispense isolated cells into a Takara Bio USA ICELL8® 5,184 well chip. Human peripheral blood mononuclear cells, also known as PBMCs, were counted on the ORFLOW Moxi Flow cytometer, diluted to 50,000 cells/mL, and stained with Hoechst and propidium iodide (PI) dye. The stained cells were then loaded into a 2×4 set of wells on a 384-well source plate (positions A1 through D2, 80 μL per well). A volume of 25 μL of negative control reagent mix (containing only buffer) was added to position A24, and 25 μL of positive control reagent mix (comprising buffer and control RNA) was added to position P24. The source plate and an empty ICELL8® 350 nL 5,184 well chip was then placed in the chamber of the liquid handling system. The cell dispense step was initiated by the controlling computer software, which starts the dewpoint control system, triggers the dynamic calculation of all the aspiration and dispense volumes required for each step, and determines the optimal dispense path that will be taken. The aspiration volumes are a function of the number of target wells, the target dispense volume per well, and an added volume of one (1) μl of overhead to facilitate dispensing the final volumes from the syringe. The dispense path optimization algorithm attempts to minimize the XY stage travel and maximizes the number of times the nanosyringes can dispense simultaneously, thereby minimizing the overall dispense time.

Prior to the beginning of the dispense, an initial cylinder wash step was done by implementing a sequence of maximal stroke length aspirations at programmed Vmax of 10 mm/sec and A1 of 40 mm/sec² from fluid supplied from the bleach or water trough followed by purging the contents into the waste trough at a programmed Vmax of 300 mm/sec and A1 of 5,000 mm/sec². For this experiment, one 0.2% bleach aspiration-purge cycle was followed by 7 water aspiration-purge cycles. At the end of the nanosyringe cylinder wash, the plunger remained in the lowest position (that is with the plunger extend as far as possible into the cylinder channel such that the distal end of the plunger is as close as possible to the orifice at the distal end of the cylinder) so that it is in the correct position for aspiration.

At this point the specific aspiration-dispense-wash cycles can begin. Generally speaking, within dispense steps are multiple aspiration-dispense-wash cycles. For this experiment the 35 nL cell dispense step consisted of five cycles: negative control dispense, cell dispense first pass, cell dispense second pass, cell dispense third pass, and finally the positive control dispense. The following describes in detail the aspiration-dispense-wash cycle.

To aspirate, the movable stage positioned the target wells of the 384-well source plate beneath the nanosyringe cylinders, and the nanosyringe assembly was lowered to a position such that the nanosyringe cylinders were 0.5 mm above the bottom of the source wells. The default Vmax for all aspirations used for this experiment was 1 mm/sec (although other speed settings can be used, for example, 10 mm/sec, or any value between 1 and 10 mm/sec). This relatively low aspiration speed was used in order to minimize the shear forces experienced by cells as they pass through the 125 micron orifice and maximize cell viability, although higher speeds could be used for reagent aspiration. After the aspiration was complete, the nanosyringe cylinders were raised above the source plate and the movable stage positioned the nanosyringe cylinders over the nanowell chip wells at 450 microns over the top surface of the nanowell chip. The dispense was at a programmed Vstart, V1, and Vmax of 66.5 mm/sec, A1 of 4,768 mm/sec², motor current setting of 900 mA, and motor microstep mode of 6400 microsteps per revolution. After the dispense is complete, the remaining 1 μL of fluid is discarded in the waste trough and the cylinder/orifice wash sequence is run to reset the condition of the cylinders. For the 35 nL cell dispense step, this cycle was repeated 5 times, to fill the nanowell chip with cells and a predetermined pattern of positive and negative controls.

After the 35 nL cell dispense step was completed, the nanowell chip was blotted with blotting paper to remove any small drops that might have landed on the top surface, sealed with RC sealing film (Takara Bio USA, Inc., San Jose CA), and the chip was spun down in a centrifuge at 300×g for five minutes at 4° C. The chip was placed back on the liquid handler's working platform.

A cell scan was initiated through the controlling software suing the on-board camera system. The camera optics first scanned the entire chip with the UV LED (365 nm) to excite the Hoechst live cell stain. The field of view of the camera spans a grid of 6×6 nanowells, and at each location a series of 7 images are taken at a depth of 2.2 mm from the top surface of the chip, then stepped up by 0.1 mm per image. This is in order to acquire images of cells that might not be at the bottom of the wells and might have stuck to the side walls. The optics system then switched to the blue LED (460 nm) to excite the propidium iodide (PI) stain, collectively to distinguish live from dead cells.

After the completion of the image acquisition, the chip was removed from the liquid handler, re-sealed, and frozen at −20° C. for one hour minimum to lyse the cells. At this time the software was used to process the images and determine which nanowells contained a single live cell. The algorithm begins by flattening the stack of Z images (images taken in different z-axis planes) into a single image, then determining how many cell-shaped objects were present in each well. If a cell-shaped object appeared in both the Hoechst and PI channel, and those objects were co-located, the cell was considered dead. Likewise, if a cell-shaped object appeared in the Hoechst channel, but not the PI channel, it was considered a live cell The dispense of the cell-containing liquid results in a Poisson distribution in the number of cells per well. The software then generated a “filter file” which represented the location of all the wells that contained a single live cell, also referred to as “candidates.” In this experiment, 1601 single live PBMC dispense candidates were identified on the chip dispensed with the nanosyringes, and 1539 candidates were identified on the chip dispensed with the ICELL8® cx system. For every subsequent dispense, the target wells were limited to the wells specified in the filter file.

At this point, the first strand cDNA synthesis by reverse transcriptase was executed in each well that contained a single cell. The nanowell chip was taken out to thaw and the RT mix was prepared and loaded into a fresh source plate as per the SMART-Seq® Pro protocol. The source plate and nanowell chip were placed back into the liquid handler and the dispense was initiated. The RT dispense step was initiated in the software and the liquid handler dispensed 35 nL of RT mix into the wells specified by the filter file in the same fashion as described above. The chip was then blotted, sealed, and spun down in the centrifuge at 3,220×g (minimum 2,600×g) for three minutes at 4° C. While the chip was being centrifuged, three additional cylinder wash steps were performed on the liquid handler. After centrifugation, the chip was removed and placed in a Bio-Rad Laboratories T-100 thermocycler (Bio-Rad Laboratories, Hercules, CA) and subject to thermal cycling.

The following steps were then followed according to the manufacturers protocol, including the necessary dispensing and thermal cycling:
(i) Full-length cDNA Amplification by PCR1
(ii) Dispense of Index Primer Set 1 (reverse indexing primers)
(iii) Tagmentation
(iv) Dispense of Index Primer Set 2 (forward indexing primers) and PCR2
(v) Extract the resulting NGS library from the chip into a single collection tube (including centrifuging the chip to collect the liquid volumes from each nano well, according to the ICELL8® cx Single-Cell System recommended protocol.

The extracted library material was then purified and sequenced on an Illumina® NextSeq® 500 sequencing system at a read length of 2×75 bp. The sequencing data was demultiplexed and analyzed using Cogent AP and DS bioinformatics packages (Takara Bio USA, Inc., San Jose CA).

An average of 127,115 barcoded reads and 2,953 genes were identified for each single cell, and seven unique cell clusters were extracted based on UMAP analysis. The library also demonstrated prominent quality metrics: 81.84% of the reads are uniquely mapped to the human reference genome, exon reads were greater than 52%, with minimum contamination from intergenic reads (5%), mitochondrial reads (7.28%) and ribosomal reads (4.87%).

The side-by-side experiments running on ICELL8® cx with the same PBMCs showed comparable results. A total of 1539 wells containing single-cell candidates were identified. The average sequencing depth was 148,382 barcoded reads per cells and an average of 3,487 genes were identified. The same number (i.e., seven) of unique cell clusters were extracted based on UMAP analysis. This ICELL8® cx library had 79.48% uniquely mapped reads, with 51.80% exon reads, with minimum contamination from intergenic reads (4.33%), mitochondrial reads (7.99%), and ribosomal reads (5.57%). The reagent dispense time for each step is faster for on the new nanosyringe system as compared to the ICELL8® cx.

To summarize, this SMART-Seq® Pro protocol for transcriptome analysis of single PBMC cells can be effectively executed using the nanosyringes for liquid handling as described in the present disclosure. Use of the nanosyringes as described herein enabled full length transcriptome analysis of single cells in conjunction with the Takara Bio USA Inc., ICELL8® 5,184 well chip, and furthermore, executed the SMART-Seq® Pro protocol as well as the ICELL8 cx Single-Cell System liquid handler.

### Example 9

### Assessment of QPCR Detection Linearity Using a Nanosyringe

A study was conducted to compare the qPCR detection linearity of the dispensing nanosyringe dispensing system as described in the present disclosure to the current state of the art microsolenoid nanofluidic device (MSND, Takara Bio, USA Inc., FIG. 15). A set of TaqMan® assays for 24 gastrointestinal infection targets (provided in the table below).

| Assay # | Organism | Gene |
|---|---|---|
| 1 | Enteroaggregative | aaiC |
| | E. coli | |
| 2 | Enteroaggregative | aatA |
| | E. coli | |
| 3 | Enteroaggregative | aar/ORF61 |
| | E. coli | |
| 4 | Enteropathogenic | bfpA |
| | E. coli | |
| 5 | Enteroaggregative | STp |
| | E. coli | |
| 6 | Shigatoxigenic | stx2 |
| | E. coli | |
| 7 | E. coli O157 | rfbE |
| 8 | Plesiomonas shigelloides | gyrB |
| 9 | Salmonella enterica | ompC 2 |
| 10 | S. enterica serovar | STY0201 |
| | Typhi | |
| 11 | Yersinia enterocolitica | lytA/lysP |
| 12 | Cryptosporidium parvum | LIB13 |
| 13 | Enteroaggregative | aggR |
| | E. coli | |
| 14 | Enteropathogenic | eae |
| | E. coli | |
| 15 | Enterotoxigenic | LT |
| | E. coli | |
| 16 | Shigatoxigenic | stx1 |
| | E. coli | |
| 17 | Clostridium difficile | tcdB |
| 18 | Clostridium difficile | tcdA |
| 19 | Salmonella enterica | ttr |
| 20 | Salmonella enterica | ompC 1 |
| 21 | Salmonella enterica | invA |
| 22 | Shigella/EIEC | ipaH |
| 23 | Vibrio cholerae | hlyA |
| 24 | Vibrio parahaemolyticus | toxR |

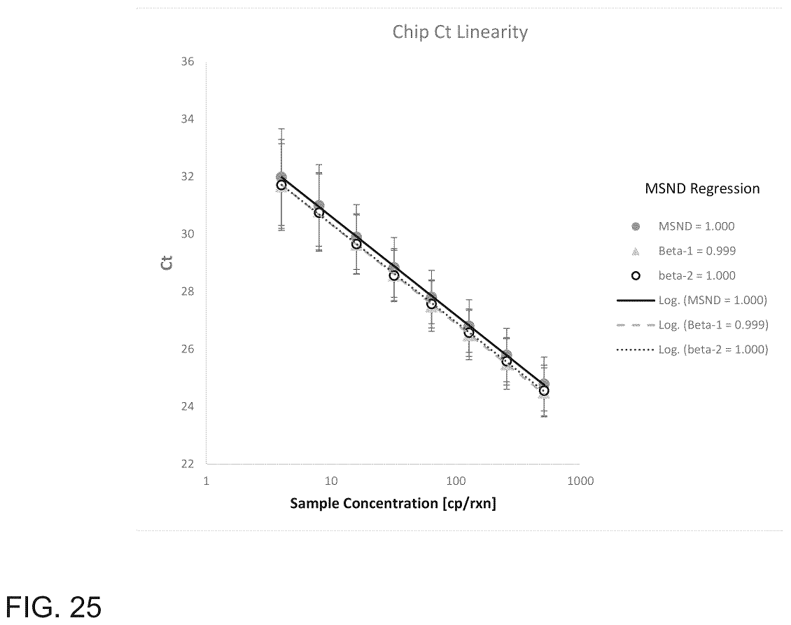

We used 5×PrimePath qPCR Mix (Takarabio catalog #638347) with 400 nM ROX spiked-in as a passive reference. The target probes were FAM-labeled and used at 250 nM concentration and the forward and reverse primers were at 900 nM concentration each. The templates were plasmids containing the amplicons of interest. These were serially diluted 1:2 with EASY Dilution (for Real Time PCR) Solution (Takarabio catalog #9160). Using both the nanosyringe device of the current disclosure and the prior art device (MSND), we first dispensed a 50 nL mix of assay and reagent in each nanowell followed by another dispense comprising 50 nL sample into each well for a total reaction volume of 100 nL. All assays were dispensed in triplicate. The experiment was conducted using one MSND device and two of the nanosyringe devices of the current disclosure. After dispensing, the reactions were cycled for qPCR and fluorescence signals in each well were detected using the SmartChip Real-Time PCR Cycler (Cat. No. 640023, Takara Bio, USA Inc.). FIG. 25 shows the results. The Ct values were plotted on the Y axis and log concentration of the copies of template per reaction on the X axis. From this result it is shown that the nanosyringe device of the current disclosure and the prior art device perform with equivalent detection linearity since the regression fit of the curves to the MSND curve is either at or close to 1.0.

### Example 10

### Use Nanosyringe Liquid Handling for Combinatorial Indexing Workflow

A study was conducted to demonstrate the performance of a nanosyringe liquid handling system of the present disclosure in conducting single-cell combinatorial indexing protocol for high-throughput single-cell full-length transcriptome analysis, e.g., as described in international application serial no. PCT/US2022/053883 published as WO 2023/122309, the disclosure of which is herein incorporated by reference.

Human K562 and mouse 3T3 cell lines were used in the analysis. 1 million K562 and 1 million 3T3 cells were mixed and washed with PBS. The resultant cell mixture was then fixed by incubation in an appropriate fixation solution (e.g., 1% paraformaldehyde) for 15 minutes. The cell fixation was stopped by adding a quenching solution (1M Tris-CI, pH8) and cells were washed by PBS. Fixed cells were aliquoted to a 96-well plate and mixed with a fragmentation buffer comprising 125 mM Tris pH8.8, 250 mM KOAc, 50 mM MgCl₂, DTT, MgCl₂, dNTPs and random hexamer. Cellular RNAs were fragmented by heating at 85° C. for 6 minutes, and reverse transcription Mastermix comprising Digitonin, RNase Inhibitor, reverse transcriptase (200 u/μl), & indexed Template Switch Oligo (TSO) was then added to the heat-treated cells, and the RT reaction carried out by incubating the pate at 10° C. for 10 min, 15° C. for 10 min, 20° C. for 10 min, 25° C. for 10 min, 30° C. for 10 min, 35° C. for 10 min, 42° C. for 70 min, and hold at 4° C. The first well-specific barcode (BC1) was added during reverse-transcription (RT) reaction in situ by use of template switching oligos (TSOs), each carrying a unique a first well-specific barcode (BC1).

After RT, the cells were pooled, washed, and then split again by cell dispensing using the nanosyringe liquid handling system. A 50 nl droplet containing an average of 5 cells, each carrying a different first well-specific barcode, was dispensed into each nanowell of 5184 nano well ICELL8 chip (Takara Bio USA, Inc. San Jose CA). Sequentially, a 50 nl droplet of a first partial second round well-specific barcode (BC2a) was deposited to cell-containing wells. Then, a second 50 nl droplet comprising a second partial second round well-specific barcode (BC2b) was added to the same wells. Finally, a 50 nl droplet of PCR mastermix containing SeqAmp DNA polymerase and 2×CB buffer was then added into each cell-containing well using the nanosyringe liquid handling system.

The subsequent PCR reaction was carried out in the nanowells of the ICELL8 chip with the following program: 94° C. 1 min; 5 cycles of 100° C. 15 s, 49.3° C. 5 s, 54.5° C. 10 s, 72.2° C. 9 s, 67.9° C. 31 s; 67.9° C. 2 min, hold at 4° C. Each nanowell contained a unique combination of BC2a and BC2b, which together create a second well-specific barcode, incorporated into the final library DNA during PCR. The final library DNAs from each individual cell had unique combinations of first and second well-specific barcodes, which when combined create a unique cell source specific barcode for each cell. After the PCR reaction, the library was pooled and cleaned up by 0.7× magnetic beads. The beads were eluted with 56 μl H2O. Four ZapR™ (Takara Bio USA, Inc. San Jose CA) reactions were set up to remove rRNA from the library. Each ZapR reaction contains 2.2 μl 10× ZapR buffer, 2.8 μl scZapR, 2.1 μl heated probe and 13.7 μl purified PCR product, and the ZapR reaction was carried out at 37° C. for 1 h and 72° C. for 10 min. After ZapR was completed, a second PCR reaction was performed to amplify the library by adding 80 μl PCR mix (2 μl SeqAmp DNA polymerase, 2 μl PCR2 Primers, 50 μl 2×CB buffer and 26 μl nuclease-free water) to each tube containing 22 μl ZapR products under the following program: 94° C. 1 min; 10 cycles of 98° C. 15 s, 55° C. 15 s, 68° C. 30 s; hold at 4° C. After the second PCR reaction, the products were purified by 0.7× magnetic beads and quantified by Qubit, BioAnalyzer and qPCR. Based on the quantification, 1.5 μM library DNA and 1% PhiX was loaded to the Nextseq500 with the mid-output 150 cycles (2×75 bp) kit for sequencing. The Cogent NGS Analysis Pipeline (Takara Bio USA, Inc. San Jose CA) was used to analyze the sequencing reads and map them to both human and mouse genomes.

As shown in the table below, 92.8% of the sequencing reads were successfully barcoded and only 7.2% of the total reads were undetermined, indicating that combinatorial indexing was successfully achieved to barcode individual single cells.

The above results demonstrate that a liquid dispensing system of the present disclosure may be used to perform barcoding applications as described in international application serial no. PCT/US2022/053883 published as WO 2023/122309; the disclosure of which is herein incorporated by reference.

### Demultiplexing Result of the Sequencing Data

| | Reads count | Ratio |
|---|---|---|
| Barcoded | 164,547,548 | 92.8% |
| Undetermined | 12,829,353 | 7.2% |

As shown in the table below, a total of 4,271 human cells were analyzed with 14.8% unmapped reads and 85.2% mapped reads. Out of the mapped reads, there were 95.5% uniquely mapped and 4.5% multi-mapped reads. Among the uniquely mapped reads, there were 44.6% exon reads, 44.6% intron reads, 10.6% intergenic reads. There were 0.8% mitochondrial and 2.6% ribosomal reads. An average of 3242 genes were detected per cell at an average sequencing depth of 12,658 reads per cell. The doublet per 1000 cells was 0.8%.

In summary, this combinatorial indexing protocol for high-throughput single-cell transcriptome analysis was shown to be successfully executed using the nanosyringe liquid handling system as described herein in conjunction with the Takara Bio USA Inc., ICELL8® 5,184 well chip.

### Mapping Metrics of the Human Cells

| Metrics | |
|---|---|
| Cell # for analysis | 4,173 |
| Unmapped reads % | 14.7% |
| Mapped reads % | 85.3% |
| Uniquely mapped % | 95.5% |
| Multi-mapped % | 4.5% |
| Exon reads % | 44.6% |
| Intron reads % | 44.6% |
| Intergenic reads % | 10.6% |
| Mitochondrial reads % | q0.8% |
| Ribosomal reads % | 2.6% |
| No of Genes | 3242 |
| Seq Depth (reads/cell) | 12,658 |
| Doublet rate per 1000 cells | 0.8% |

### FURTHER CONSIDERATIONS

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. Unless otherwise expressed, reference to an element in the singular is not intended to mean “one and only one” unless explicitly stated, but rather is meant to mean “one or more.” In addition, it is not necessary for a device or method to address every problem that is solvable (or possess every advantage that is achievable) by different embodiments of the disclosure in order to be encompassed within the scope of the disclosure.

1. A liquid handling device, the device comprising:
(a) an actuator comprising a movable shaft;
(b) an elongated body comprising a central channel, a proximal end and a distal end, wherein the distal end comprises an orifice; and
(c) a plunger comprising a proximal end and a distal end, wherein:
(i) the proximal end is mechanically coupled to the movable shaft, and
(ii) at least a portion of the distal end of the plunger is moveably positioned within the central channel.

2. The device of claim 1, further comprising a support structure that is physically coupled to and stabilizes the actuator, the elongated body and the plunger.

3. The device of claim 1, wherein the actuator is a mechanical actuator.

4. The device of claim 3, wherein the mechanical actuator comprises a stepper motor.

5. The device of claim 1, wherein the actuator is a linear actuator.

6. The device of claim 1, wherein the device is configured for both aspirating and dispensing liquid through the orifice.

7. The device of claim 1, wherein the elongated body comprises a cylinder.

8. (canceled)

9. The device of claim 1, wherein the elongated body further comprises a port located on the side of the elongated body and fluidically coupled to the central channel.

10. The device of claim 1, wherein the orifice has a diameter that is smaller than the inner diameter of the central channel.

11. (canceled)

12. (canceled)

13. The device of claim 1, wherein the elongated body and the orifice are machined from a cylindrical rod.

14. The device of claim 1, wherein the orifice is part of an orifice plate coupled to the distal end of the elongated body.

15. (canceled)

16. (canceled)

17. (canceled)

18. (canceled)

19. (canceled)

20. The device of claim 1, wherein the plunger is a stainless steel plunger.

21. (canceled)

22. The device of claim 1, wherein the outer diameter of the plunger is smaller than the inner diameter of the central channel.

23. (canceled)

24. The device of claim 1, wherein the distal end of the plunger further comprises a plunger seal.

25. The device of claim 1, further comprising a seal that encompasses the junction between the proximal end of the elongated body and plunger.

26. The device of claim 1, further comprising a seal that encompasses the proximal end of the elongated body, the seal surrounding both the outer surface of at least a portion of the proximal end of the elongated body and surrounding the plunger at a position of the plunger where the plunger emerges from the proximal end of the elongated body.

27. (canceled)

28. (canceled)

29. (canceled)

30. (canceled)

31. (canceled)

32. (canceled)

33. (canceled)

34. (canceled)

35. A system for the simultaneous handling of a plurality of liquid samples, the system comprising:
(i) a nanosyringe array comprising a plurality of nanosyringes, each nanosyringe comprising:
(a) an actuator comprising a movable shaft;
(b) an elongated body comprising a central channel, a proximal end and a distal end, wherein the distal end comprises an orifice; and
(c) a plunger comprising a proximal end and a distal end, wherein:
the proximal end is mechanically coupled to the movable shaft, and
at least a portion of the distal end of the plunger is moveably positioned within the central channel; and
(ii) a computer control system for controlling the actuator.

36. The system of claim 35, wherein the system is configured to accommodate a multi-well device in a liquid receiving relationship with the nanosyringe array.

37. (canceled)

38. The system of claim 35, further comprising a housing that comprises the nanosyringe array.

39. The system of claim 38, where the housing forms an environmentally-controllable chamber.

40-74. (canceled)
